(19) United States
(12) Patent Application Publication
(10) Pub. No.: US 2016/0091826 A1
(43) Pub. Date: Mar. 31, 2016

(54) DEVELOPING DEVICE AND IMAGE FORMING APPARATUS

(71) Applicant: CANON KABUSHIKI KAISHA, Tokyo (JP)

(72) Inventor: Mitsuhiro Furukawa, Chofu-shi (JP)

(21) Appl. No.: 14/855,548

(22) Filed: Sep. 16, 2015

(30) Foreign Application Priority Data
Sep. 26, 2014 (JP) 2014-195947

(51) Int. Cl. G03G 15/09

(52) U.S. Cl. CPC G03G 15/0889; G03G 15/0907

(57) ABSTRACT

A collection roller and a developing sleeve rotate in the same direction at proximal portions thereof. A distal end of a magnetic brush formed of developer born on a surface of the developing sleeve by an importing magnetic pole of a magnet roller is set so as to make contact with the surface of the collection roller. A first gap is set between the collection roller and the developer-bearing region of the developing sleeve and a second gap larger than the first gap is set between the collection roller and the non-developer-bearing region of the developing sleeve.

### BACKGROUND OF THE INVENTION

1. Field of the Invention

The present invention relates to a developing device used in an image forming apparatus which employs an electrophotographic system or an electrostatic recording system.

2. Description of the Related Art

As a developing device that develops an electrostatic latent image formed on an image bearing member according to an electrophotographic system or an electrostatic recording system using a mono-component developer or a two-component developer, a developing device that includes a developing sleeve having a magnetic pole fixed therein is employed.

The developing sleeve is rotatably supported on an opening of the developing device with bearing at both ends interposed, and the surface of the developing sleeve is roughened by blasting or the like. Alternatively, in some developing sleeves, grooves formed along a longitudinal direction thereof are arranged regularly in a circumferential direction thereof. The developing device conveys the developer born on the surface of the developing sleeve to a developing region that an image bearing member faces, supplies the developer to an electrostatic latent image on the image bearing member, and develops the electrostatic latent image.

When the amount of developer born on the surface of the developing sleeve is uneven, the image developed by supplying developer to the electrostatic latent image on the image bearing member also has an uneven density, and an image defect occurs. Thus, it is desirable to control the amount of developer born on the surface of the developing sleeve to be even. Thus, the amount of developer born on the surface of the developing sleeve is regulated to be even by a regulating member called a regulating blade.

On the other hand, the developing device includes a developing container that stores developer. A conveying member such as screws is provided in the developing container, and the developer is circulated and conveyed in the developing container by the conveying member.

In recent years, the processing speed of the electrophotographic-system image forming apparatus has increased. Scattering toner occurring near a developing region that the image bearing member faces contaminates the inside of the developing device and the image forming apparatus. Moreover, the scattering toner adheres to a recording material to deteriorate the image quality. With an increase in the processing speed, such a phenomenon tends to be more remarkable. The toner scatters due to centrifugal force associated with rotation of the developing sleeve and the falling of a magnetic brush formed of the developer formed on the surface of the developing sleeve. With an increase in the processing speed, the scattering toner tends to increase.

As a developing device that solves such a problem, a developing device including a collection roller that is disposed closer to a downstream side in a rotation direction of an image bearing member than a developing region that the image bearing member faces so as to be separated by a predetermined interval from an outer circumferential surface of the image bearing member and that collects scattering toner by rotating is proposed.

For example, a developing device disclosed in Japanese Patent Laid-Open No. 2006-78675 causes scattering toner to be adsorbed to the surface of a collection roller. Further, a scraper of which a planar long edge makes contact with the surface of the collection roller to scrape scattering toner adsorbed to the surface of the collection roller is provided. Moreover, the toner scraped by the scraper is collected into the developing device.

In such a collection roller, the gap formed between the surface of the developing sleeve and the surface of the collection roller is generally set to approximately 1 mm to 3 mm so as not to make contact with a magnetic brush formed of the developer formed on the surface of the developing sleeve.

However, the gap formed between the surface of the developing sleeve and the surface of the collection roller is disposed so as not to make contact with the magnetic brush formed of the developer formed on the surface of the developing sleeve. In this case, with an increase in the processing speed, a non-negligibly large amount of toner may be stirred up by a conveying screw inside the developing container and may scatter outside the developing container from the gap formed between the surface of the developing sleeve and the surface of the collection roller.

The present invention solves the problem and is desirable to provide a developing device capable of suppressing scattering of toner from a gap formed between the surface of a developer bearing member and the surface of a collection rotating member.

### SUMMARY OF THE INVENTION

According to a representative configuration of a developing device according to the present invention for attaining the object, there is provided a developing device comprising: a developing container which stores developer; a developer bearing member which develops an electrostatic latent image, the developer bearing member being provided in an opening formed in the developing container so as to be rotatable in relation to the developing container in a state in which a surface thereof is partially exposed; a magnet member which is disposed in the developer bearing member and has a plurality of magnetic poles in a circumferential direction of the developer bearing member in order to allow developer to be born on a surface of the developer bearing member; a collection rotating member disposed in the opening of the developing container closer to an opening end formed on a downstream side in a rotation direction of the developer bearing member so as to face the developer bearing member at an interval from the developer bearing member and collect toner by rotating so that surfaces of the developer bearing member and the collection rotating member move in the same direction at proximal positions thereof; and a bias application device which applies a bias to the collection rotating member so that an electric field is formed so that force directed from the collection rotating member toward the developer bearing member acts on normally charged toner, wherein a distal end of a magnetic brush formed of the developer born on the surface of the developer bearing member by the magnet member is set so as to make contact with the surface of the collection rotating member, the developer bearing member has a developer-bearing region formed so that the developer is born on a surface thereof, and a non-developer-bearing region formed so that the developer is not born, and a first gap is set between the collection rotating member and the developer-bearing region and a second gap larger than the first gap is set between the collection rotating member and the non-developer-bearing region.

Further features of the present invention will become apparent from the following description of exemplary embodiments with reference to the attached drawings.

### BRIEF DESCRIPTION OF THE DRAWINGS

FIG. 1 is an explanatory cross-sectional view illustrating a configuration of an image forming apparatus including a developing device according to the present invention.

FIG. 2 is an explanatory cross-sectional view illustrating a configuration of the developing device according to the present invention.

FIG. 3 is an explanatory cross-sectional view illustrating a state in which developer circulates in the developing device according to the present invention.

FIG. 4 is an explanatory cross-sectional view illustrating a configuration of a first embodiment of the developing device according to the present invention.

FIG. 5 is an explanatory cross-sectional view illustrating a state in which a distal end of a magnetic brush formed of the developer born on the surface of a developer bearing member according to the first embodiment makes contact with the surface of a collection rotating member.

FIG. 6 is an explanatory cross-sectional view illustrating a state in which a toner leakage occurs since the distal end of a magnetic brush formed of the developer born on the surface of a developer bearing member of a developing device according to Comparative Example 1 does not make contact with the surface of the collection rotating member.

FIG. 7 is an explanatory cross-sectional view illustrating an effective range of a magnetic pole disposed at the position facing the collection rotating member according to the first embodiment.

FIG. 8A is a table illustrating setting conditions and the effects of the first embodiment, the modified embodiment (Example 1-2), and Comparative Examples 1, 3, and 5.

FIG. 8B is a table illustrating setting conditions and the effects of the second embodiment, Comparative Example 1, and the first embodiment.

FIG. 8C is a table illustrating setting conditions and the effects of the second and fifth embodiments.

FIG. 9 is an explanatory cross-sectional view illustrating a configuration of the second embodiment of the developing device according to the present invention.

FIG. 10 is an explanatory cross-sectional view illustrating a configuration of an end in the longitudinal direction of the developing device.

FIG. 11 is an explanatory cross-sectional view illustrating a configuration of the third embodiment of the developing device according to the present invention.

FIG. 12 is an explanatory cross-sectional view illustrating a manufacturing method of forming a groove in a surface of the developer bearing member according to the third embodiment and then cutting both ends in the longitudinal direction to decrease an outer diameter.

FIG. 13 is an explanatory cross-sectional view illustrating a configuration of the fourth embodiment of the developing device according to the present invention.

FIG. 14 is an explanatory cross-sectional view illustrating a configuration of the fifth embodiment of the developing device according to the present invention.

### DESCRIPTION OF THE EMBODIMENTS

Embodiments of an image forming apparatus including a developing device according to the present invention will be described in detail with reference to the drawings.

A developing device 1 described below is used in an image forming apparatus 16 described below, for example, but is not necessarily limited to this embodiment.

For example, the image forming apparatus 16 can be used regardless of whether the developing device used is a tandem-type or a mono-drum-type developing device and the transfer portion is an intermediate transfer-type and a direct transfer-type transfer portion and can be used regardless of whether the developer used is a two-component developer or a mono-component developer.

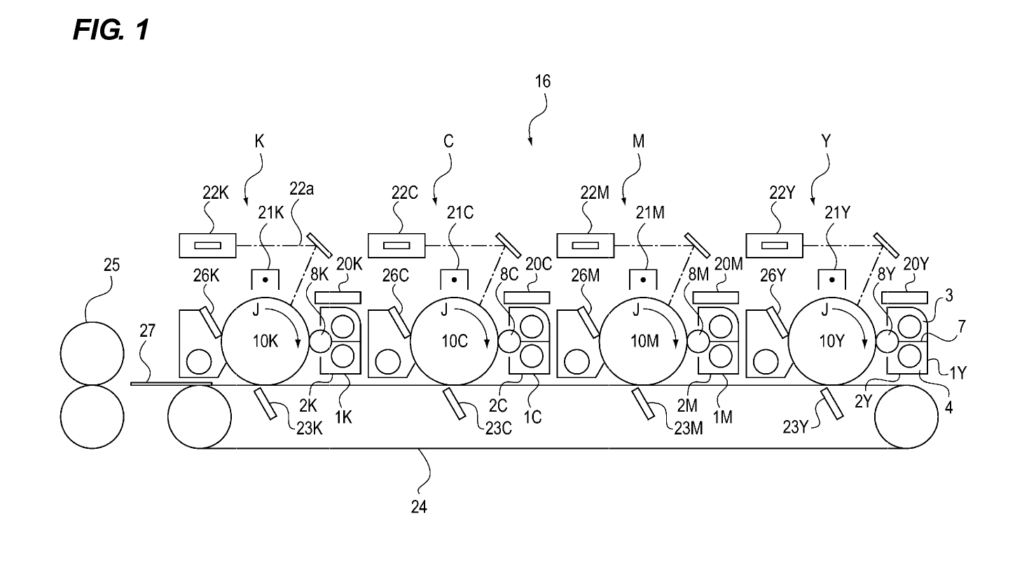

In the present embodiment, although the main portions associated with formation of a toner image are illustrated and described with reference to FIG. 1, various devices, equipment, and housing structures may be added as necessary and be used for various uses such as various printers, copying machines, facsimile apparatuses, and multi-functional peripherals in which these functions are combined.

### First Embodiment

First, a configuration of a first embodiment of an image forming apparatus including the developing device according to the present invention will be described with reference to FIG. 1 to FIGS. 8A to 8C.

### <Image Forming Apparatus>

The image forming apparatus 16 illustrated in FIG. 1 includes stations of the colors yellow Y, magenta M, cyan C, and black K. FIG. 1 illustrates a positional relation in each station, between the developing device 1 and a photosensitive drum 10 serving as an image bearing member that rotates in a predetermined direction (the direction indicated by arrow J in FIG. 1) while bearing an electrostatic latent image thereon.

The stations of the colors yellow Y, magenta M, cyan C, and black K illustrated in FIG. 1 have approximately the same configuration and form images of the colors yellow Y, magenta M, cyan C, and black K, respectively, in a full-color image formation mode.

In the following description, a developing device 1Y, a developing device 1M, a developing device 1C, and a developing device 1K in the stations of the colors yellow Y, magenta M, cyan C, and black K are sometimes described using the developing device 1 as a representative developing device. The same is applied to the other image formation process portions.

First, an overall configuration of the image forming apparatus 16 will be described with reference to FIG. 1. In FIG. 1, the photosensitive drum 10 which is the image bearing member is provided so as to be rotatable in the direction indicated by arrow J in FIG. 1 by a driving portion (not illustrated). The surface of the photosensitive drum 10 rotating in the direction indicated by arrow J in FIG. 1 is charged uniformly by a charger 21 serving as a charging portion.

The surface of the photosensitive drum 10 uniformly charged by the charger 21 is irradiated with a laser beam 22a modulated according to an image information signal by a laser scanner 22 serving as an image exposing portion whereby an electrostatic latent image is formed.

The electrostatic latent image formed on the surface of the photosensitive drum 10 is supplied with developer T by the developing device 1 serving as a developing portion and is visualized as a developer image (toner image).

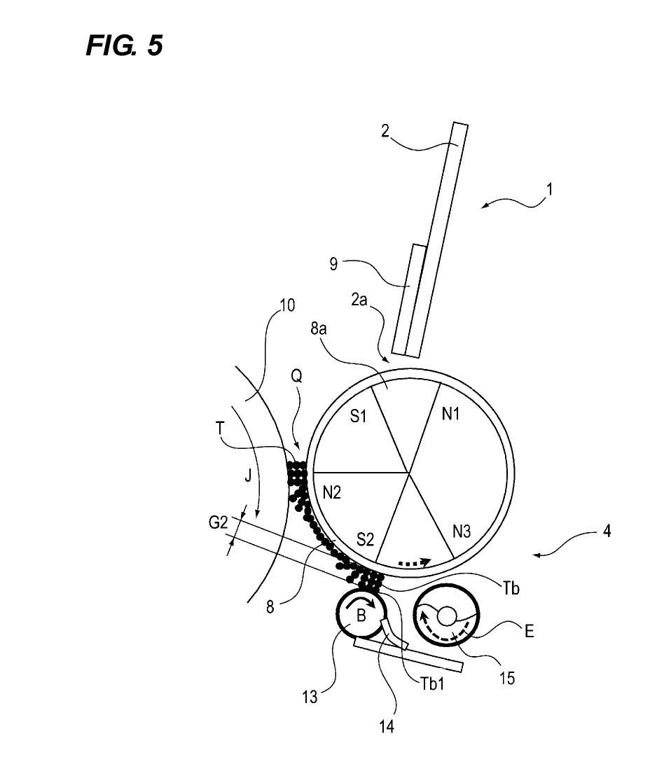

In the developing device 1, a developing sleeve 8 serving as a developer bearing member is provided in a developing region Q that faces the photosensitive drum 10 illustrated in FIG. 5. The developing sleeve 8 develops the electrostatic latent image formed on the surface of the photosensitive drum 10. The developing sleeve 8 includes a magnet roller 8a serving as a magnet member that is disposed in the developing sleeve 8 and has a plurality of magnetic poles in the circumferential direction of the developing sleeve 8 in order to allow the developer to be born on the surface of the developing sleeve 8. The developing sleeve 8 bears the developer T including toner on the surface thereof and supplies the developer T to the developing region Q. In this way, the electrostatic latent image formed on the surface of the photosensitive drum 10 is developed by the toner.

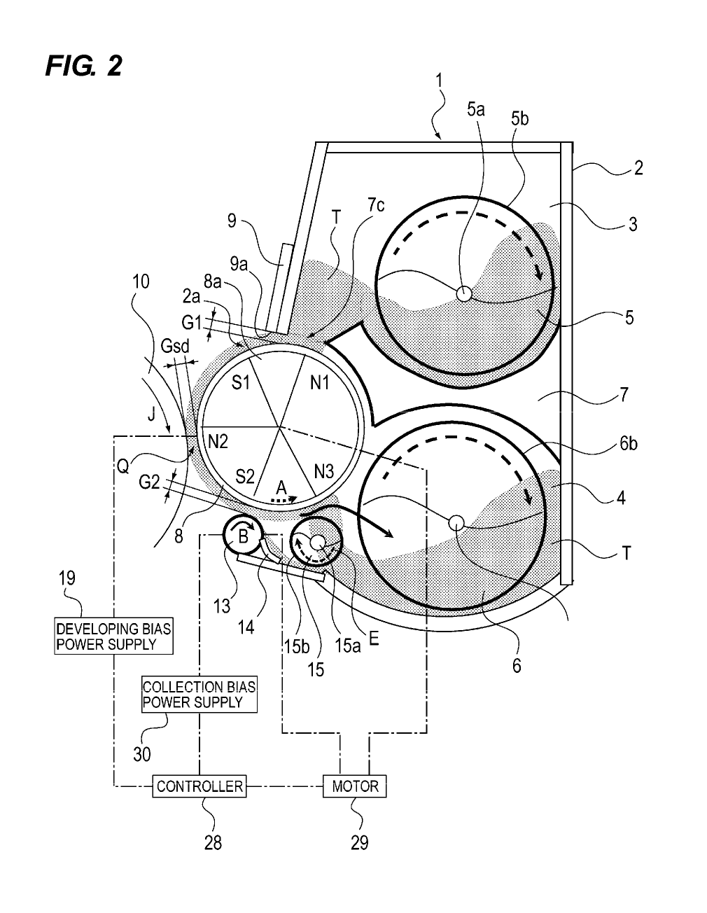

The developing sleeve 8 is applied with a developing bias voltage by a developing bias power supply 19 that is driven and controlled by a controller 28 illustrated in FIG. 2. As a result, the developer T including the toner born on the surface of the developing sleeve 8 is supplied to the surface of the photosensitive drum 10, and the electrostatic latent image is developed as a toner image.

Further, the developing device 1 includes a collection roller 13 serving as a collection rotating member that collects scattering toner. As illustrated in FIG. 2, the collection roller 13 is disposed closer to the downstream side in the rotation direction (the direction indicated by arrow J in FIG. 2) of the photosensitive drum 10 than the developing sleeve 8. Moreover, the collection roller 13 and the developing sleeve 8 are disposed so as to be separated from the outer circumferential surface of the photosensitive drum 10 so as to rotate in the same direction at proximal portions thereof.

The collection roller 13 is rotated and driven by a motor 29 serving a driving source that is rotated and driven by the controller 28 illustrated in FIG. 2. The collection roller 13 adsorbs and collects scattering toner around the collection roller 13 by rotating.

In the present embodiment, the developing sleeve 8 and the collection roller 13 are rotated by the motor 29 serving as a driving source that is driven and controlled by the controller 28 with a gear train (not illustrated) interposed so that the developing sleeve 8 rotates in the direction indicated by arrow A in FIG. 2 and the collection roller 13 rotates in the direction indicated by arrow B in FIG. 2. As a result, the collection roller 13 and the developing sleeve 8 rotate in the same direction at the proximal portions.

On the other hand, a recording material 27 is supplied from a sheet cassette (not illustrated). The recording material 27 is conveyed in a state of being born on the outer circumferential surface of a recording material conveying belt 24 at a predetermined time so as to correspond to the position of the toner image formed on the surface of the rotating photosensitive drum 10. The recording material conveying belt 24 conveys the recording material 27 to a transfer portion between the photosensitive drum 10 and a transfer charger 23 serving as a transfer portion.

The transfer charger 23 of each station transfers the toner image formed on the surface of each photosensitive drum 10 to the recording material 27 such as a sheet conveyed by the recording material conveying belt 24 in a superimposed manner.

The recording material 27 to which the toner image is transferred is heated and pressurized by a fixing device 25 serving as a fixing portion and the toner image is fixed to the recording material 27 whereby a permanent image is obtained. The transfer-residual toner remaining on the surface of each photosensitive drum 10 is removed and collected by a cleaning device 26 serving as a cleaning portion. The toner in the developer T consumed by image formation is supplied from each toner supply tank 20.

In the present embodiment, as illustrated in FIG. 1, the toner image is directly transferred from the photosensitive drums 10Y, 10M, 10C, and 10K to the recording material 27 conveyed by the recording material conveying belt 24.

Besides this, an intermediate transfer belt (not illustrated) serving as an intermediate transfer member may be provided instead of the recording material conveying belt 24. Moreover, the toner images of the respective colors formed on the surfaces of the photosensitive drums 10Y, 10M, 10C, and 10K of the respective colors are primarily transferred to the outer circumferential surface of the intermediate transfer belt.

After that, the composite toner images of the respective colors primarily transferred to the outer circumferential surface of the intermediate transfer belt are secondarily transferred collectively to the recording material 27 by a secondary transfer portion (not illustrated). The present invention can be applied to such an image forming apparatus 16.

The processing speed Vp of the image formation in the image forming apparatus 16 of the present embodiment is set to 500 mm/sec.

### <Two-Component Developer>

Next, a configuration of the two-component developer T used in the developing device 1 of the present embodiment will be described. The toner includes a colored resin particle including a binder resin, a colorant, and another additive as needed and a colored particle to which an external additive such as a colloidal silica fine powder is externally added. The toner is made of a negatively-charged polyester resin, and in the present embodiment, toner having an average particle diameter of 7.0 μm is used.

Examples of the magnetic carrier include metals such as iron, nickel, cobalt, manganese, chromium, and a rare earth metal of which the surface is oxidized or unoxidized, and alloys and ferrite oxides thereof. A method of manufacturing these magnetic particles is not particularly limited.

### <Developing Device>

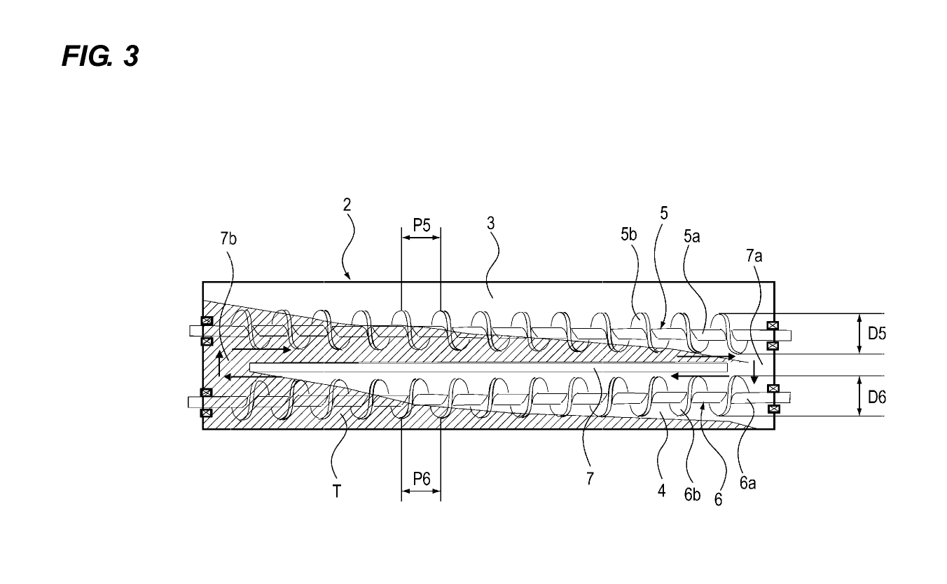

Next, a configuration of the developing device 1 will be described with reference to FIGS. 2 and 3. As illustrated in FIG. 2, the developing device 1 of the present embodiment includes the developing sleeve 8 serving as a developer bearing member in a developing container 2 in which the two-component developer T including non-magnetic toner and magnetic carrier is stored.

Further, the developing device 1 includes a regulating blade 9 serving as a developer regulating member that is provided so as to face the developing sleeve 8 and regulate the thickness of the two-component developer T born on the surface of the developing sleeve 8.

As illustrated in FIGS. 1 to 3, approximately the central portion in the developing container 2 is partitioned vertically in FIG. 2 by a partition wall 7 extending in a direction vertical to the sheet surface of FIG. 2 into a developing chamber 3 disposed in an upper portion in the developing container 2 and an agitation chamber 4 disposed in a lower portion in the developing container 2. The two-component developer T is stored in the developing chamber 3 and the agitation chamber 4 in the developing container 2.

As illustrated in FIGS. 2 and 3, conveying screws 5, 6, and 15 which are circulating portions that agitate and convey the developer T to circulate the developer T in the developing container 2 are disposed in the developing chamber 3 and the agitation chamber 4 in the developing container 2.

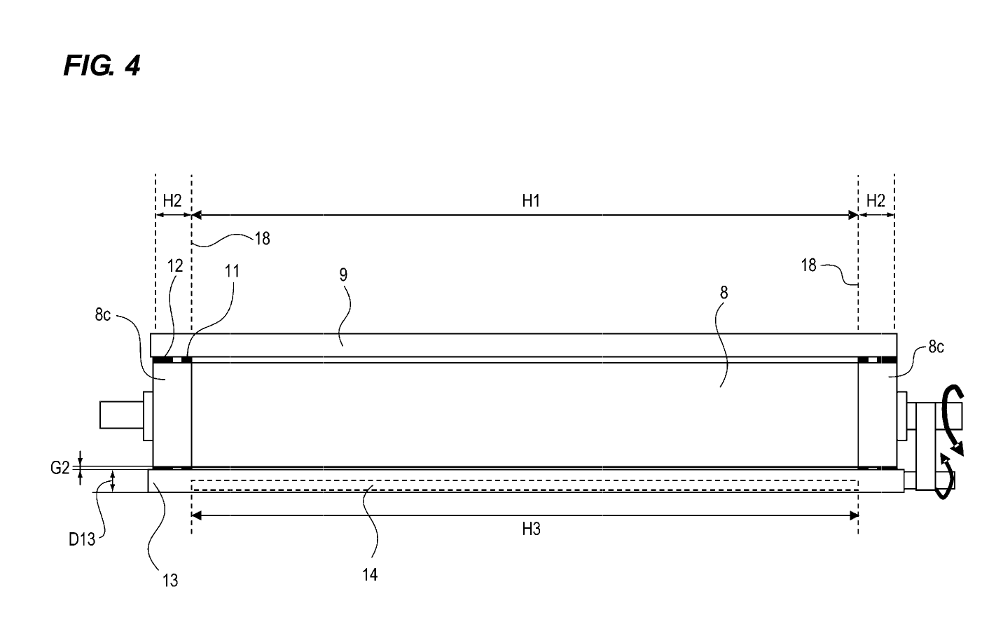

The conveying screw 5 illustrated in FIGS. 2 and 3 is disposed in a bottom portion inside the developing chamber 3 approximately in parallel to the axial direction (the left-right direction in FIG. 4) of the developing sleeve 8. Moreover, as illustrated in FIG. 3, when the conveying screw 5 rotates, a spiral agitation blade 5b provided on the outer circumferential surface of a rotation shaft 5a of the conveying screw 5 conveys the developer T in the developing chamber 3 in one direction (the rightward direction in FIG. 3) along the axial direction of the conveying screw 5.

The conveying screw 6 illustrated in FIGS. 2 and 3 are disposed in a bottom portion inside the agitation chamber 4 approximately in parallel to the conveying screw 5. Moreover, as illustrated in FIG. 3, the conveying screw 6 rotates.

As a result, a spiral agitation blade 6b provided on the outer circumferential surface of a rotation shaft 6a of the conveying screw 6 conveys the developer T in the agitation chamber 4 in an opposite direction (the leftward direction in FIG. 3) from the developer conveying direction (the rightward direction in FIG. 3) of the conveying screw 5.

The conveying screw 15 illustrated in FIG. 2 is disposed in a bottom portion inside the agitation chamber 4 approximately in parallel to the conveying screw 6 in the bottom portion of the developing sleeve 8 illustrated in FIG. 2. Moreover, when the conveying screw 15 rotates, a spiral agitation blade 15b provided on the outer circumferential surface of a rotation shaft 15a of the conveying screw 15 conveys the developer T in the agitation chamber 4 in an opposite direction (the rightward direction in FIG. 3) from the developer conveying direction (the leftward direction in FIG. 3) of the conveying screw 6.

In the developing device 1 of the present invention, the developing chamber 3 and the agitation chamber 4 in the developing container 2 are disposed vertically in FIGS. 2 and 3. Thus, when the developer T in the agitation chamber 4 provided in the bottom portion in the developing container 2 is conveyed by the conveying screw 6 only, a developer level on an up-pumping side illustrated on the left side of FIG. 3 increases.

Thus, in the present embodiment, the conveying screw 15 illustrated in FIG. 2 conveys the developer T in the agitation chamber 4 from the up-pumping side illustrated on the left side of FIG. 3 toward a down-pumping side illustrated on the right side of FIG. 3. In this way, the developer level in the agitation chamber 4 can be equalized to some extent.

With rotation of the conveying screws 5, 6, and 15 illustrated in FIGS. 2 and 3, the developer T in the developing chamber 3 and the agitation chamber 4 in the developing container 2 is conveyed.

The developer T in the developing container 2 is circulated and conveyed in a clockwise direction in FIG. 3 between the developing chamber 3 and the agitation chamber 4 through openings (communicating portions) 7a and 7b formed in both ends in the longitudinal direction (the left-right direction of FIG. 3) of the partition wall 7 illustrated in FIG. 3.

On the other hand, with rotation of the conveying screw 5, the developer T in the developing chamber 3 illustrated in FIG. 2 is supplied from an opening 7c formed between the regulating blade 9 and the partition wall 7 toward the developing sleeve 8.

The conveying screws 5, 6, and 15 illustrated in FIGS. 2 and 3 are screw structures in which the agitation blades 5b, 6b, and 15b formed of a non-magnetic material are formed in a spiral form around the rotation shafts 5a, 6a, and 15a, respectively. The outer diameters D5 and D6 of the agitation blades 5b and 6b of the conveying screws 5 and 6 are 20 mm. The screw pitch P5 and P6 of the agitation blades 5b and 6b are 30 mm.

On the other hand, the outer diameter D15 of the agitation blade 15b of the conveying screw 15 is 8 mm. The screw pitch P15 of the agitation blade 15b is 20 mm. The rotation velocity of the conveying screws 5, 6, and 15 is set to 800 rpm (rotation per minutes).

An opening 2a is formed at a position of the developing container 2 illustrated in FIG. 2 corresponding to the developing region Q that faces the photosensitive drum 10. The developing sleeve 8 serving as a developer bearing member and the collection roller 13 serving as a collection rotating member are provided so as to be rotatable in relation to the developing container 2 in a state in which the developing sleeve 8 and the collection roller 13 are partially exposed to the photosensitive drum 10 from the opening 2a formed in the developing container 2.

In the present embodiment, a gap Gsd (SD gap) formed between the surface of the developing sleeve 8 illustrated in FIG. 2 and the surface of the photosensitive drum 10 is set to approximately 250 μm.

The developing sleeve 8 is formed of a non-magnetic material, and as illustrated in FIG. 2, the magnet roller 8a which is a magnetic field generator is provided in the developing sleeve 8 in a non-rotating state. The magnet roller 8a has a developing magnetic pole N2 (N-polarity), an importing magnetic pole S2 (S-polarity) for importing the developer T, and magnetic poles S1 (S-polarity), N1 (N-polarity), and N3 (N-polarity) for conveying the developer T.

Among these magnetic poles, the magnetic poles N1 and N3 having the same polarity are provided on the inner side of the developing container 2 in an adjacent state. As a result, a repulsive magnetic field that generates a repulsive force is formed between the magnetic poles N1 and N3. Thus, the developer T is separated from the surface of the developing sleeve 8 in the agitation chamber 4.

The developing sleeve 8 rotates in the direction indicated by arrow A in FIG. 2 during a developing operation, and the regulating blade 9 provided so as to face the surface of the developing sleeve 8 cuts the magnetic brush. As a result, the two-component developer T of which the thickness is regulated is born on the surface of the developing sleeve 8. With rotation of the developing sleeve 8 in the direction indicated by arrow A in FIG. 2, the two-component developer T born on the surface of the developing sleeve 8 is conveyed to the developing region Q that the photosensitive drum 10 faces. Moreover, the developer T is supplied to the electrostatic latent image formed on the surface of the photosensitive drum 10 and the electrostatic latent image is developed as a toner image.

The regulating blade 9 which is a brush cutting member is formed of a plate-shaped non-magnetic member formed of aluminum that extends along the axial line in the longitudinal direction of the developing sleeve 8. The regulating blade 9 is disposed closer to the upstream side in the rotation direction (the direction indicated by arrow A in FIG. 2) of the developing sleeve 8 than the developing region Q that the photosensitive drum 10 faces.

Both the toner of the two-component developer T and the magnetic carrier pass through the space between a distal end 9a of the regulating blade 9 and the surface of the developing sleeve 8 and are conveyed to the developing region Q formed between the developing sleeve 8 and the photosensitive drum 10.

The gap G1 formed between the distal end 9a of the regulating blade 9 and the surface of the developing sleeve 8 is adjusted. As a result, the amount of magnetic brush cut by the regulating blade 9, of the developer T born on the surface of the developing sleeve 8 is regulated. Thus, the amount of developer conveyed to the developing region Q that the photosensitive drum 10 faces is adjusted.

In the present embodiment, a coating amount of the developer per unit area of the developer T born on the surface of the developing sleeve 8 by the regulating blade 9 is regulated to 30 mg/cm². Moreover, the ratio Vr of the circumferential velocity of the developing sleeve 8 to the circumferential velocity of the photosensitive drum 10 is set to 170%.

### <Collection Rotating Member>

Next, a configuration of the collection roller 13 serving as a collection rotating member according to the present invention will be described with reference to FIGS. 4 and 5. As illustrated in FIGS. 4 and 5, the collection roller 13 is disposed around the developing sleeve 8 closer to the downstream side in the rotation direction (the direction indicated by arrow A in FIG. 5) of the developing sleeve 8 than the developing region Q that the photosensitive drum 10 faces. The collection roller 13 is at the proximity of the developing sleeve 8, and in the proximal portion, rotates in the same direction (the direction indicated by arrow B in FIG. 5) as the rotation direction (the direction indicated by arrow A in FIG. 5) of the developing sleeve 8.

The developing sleeve 8 and the collection roller 13 are connected together in drive transmission portions provided at the ends of the rotation shafts thereof, and the collection roller 13 rotates with rotation of the developing sleeve 8. In the present embodiment, the gear ratio of the drive transmission portions is set so that the collection roller 13 makes one rotation when the developing sleeve 8 makes 25 rotations.

In the present embodiment, a collection bias power supply 30 serving as a bias application device that is driven and controlled by the controller 28 illustrated in FIG. 2 applies a collection bias voltage (bias) to the collection roller 13. As a result, an electric field is formed so that force directed from the collection roller 13 toward the developing sleeve 8 acts on the normally charged toner. In this way, the effect of collecting the scattering toner in the entire longitudinal direction (the left-right direction in FIG. 4) of the collection roller 13 can be enhanced. In the present embodiment, a DC collection bias voltage of −1000 V of the same polarity as the negatively charged toner is applied from the collection bias power supply 30 illustrated in FIG. 2 as the collection bias voltage applied to the collection roller 13.

On the other hand, a developing bias voltage in which an AC component and a DC component are superimposed is applied to the developing sleeve 8 from the developing bias power supply 19 that is driven and controlled by the controller 28. The toner on the surface of the developing sleeve 8 is supplied to the electrostatic latent image on the surface of the photosensitive drum 10 and is developed by a potential difference between the potential of the electrostatic latent image portion formed on the surface of the photosensitive drum 10 and the developing bias voltage applied to the developing sleeve 8 by the developing bias power supply 19.

In the present embodiment, a collection bias voltage having a DC component at which the normally charged toner rarely adheres to the collection roller 13 as compared to the DC component of the developing bias voltage applied to the developing sleeve 8 is applied to the collection roller 13. Due to this, the two-component developer T including the toner and the magnetic carrier does not adhere to the surface of the collection roller 13.

In the present embodiment, as illustrated in FIGS. 2, 4, and 5, the gap G2 formed between the surface of the collection roller 13 and the surface of the developing sleeve 8 is set to 700 μm.

Moreover, as illustrated in FIGS. 2 and 5, the importing magnetic pole S2 serving as the magnetic pole of the magnet roller 8a fixed inside the developing sleeve 8 is disposed at a position facing the collection roller 13. Further, the importing magnetic pole S2 (S-polarity) serving as the magnetic pole disposed closest to the collection roller 13 has adjacent magnetic poles which include the developing magnetic pole N2 (N-polarity) and the magnetic pole N3 (N-polarity) which have the opposite polarity from the importing magnetic pole S2.

Due to this, as illustrated in FIG. 5, a distal end Tb1 of a magnetic brush Tb formed of the developer T born on the surface of the developing sleeve 8 makes contact with the surface of the collection roller 13. As a result, a magnetic brush curtain formed by the magnetic brush Tb can be formed in the gap G2 formed between the surface of the developing sleeve 8 and the surface of the collection roller 13.

The developer T is stirred up by the conveying screw 15 that rotates in the direction indicated by arrow E in FIGS. 2 and 5. The developer T is blocked by the magnetic brush Tb that forms the magnetic brush curtain in the gap G2 formed between the surface of the developing sleeve 8 and the surface of the collection roller 13. Thus, the developer T does not scatter outside the developing container 2. As a result, the developer T stirred up by the conveying screw 15 is collected into the agitation chamber 4 of the developing container 2 illustrated in FIG. 2.

The developer T adhering to the surface of the collection roller 13 is scraped and removed by the scraper 14 being in contact with the surface of the collection roller 13 and is collected into the agitation chamber 4 of the developing container 2 illustrated in FIG. 2.

In the present embodiment, as illustrated in FIG. 5, the importing magnetic pole S2 of the magnet roller 8a included in the developing sleeve 8 faces the collection roller 13. Due to this, the magnetic brush Tb formed of the developer T born on the surface of the developing sleeve 8 stands up in the radial direction of the developing sleeve 8 and the collection roller 13 in the gap G2 formed between the surface of the developing sleeve 8 and the surface of the collection roller 13. A half-width value of the peak value of the magnetic flux density of the importing magnetic pole S2 of the magnet roller 8a included in the developing sleeve 8 is set to 30° at 500 Gauss.

In the collection roller 13 of the present embodiment, as illustrated in FIG. 4, the outer diameter D13 in the entire longitudinal direction (the left-right direction in FIG. 4) of the collection roller 13 is 6 mm. The outer diameter D13 in an entire region of the collection roller 13 including a coated region H1 in the central portion and a non-coated region H2 in the end 8c in the longitudinal direction (the left-right direction in FIG. 4) of the developing sleeve 8 is 6 mm. In the present embodiment, as illustrated in FIG. 4, the portion of the collection roller 13 having the outer diameter D13 of 6 mm extends up to the outer side of the non-coated region H2.

### <Toner Scattering Prevention>

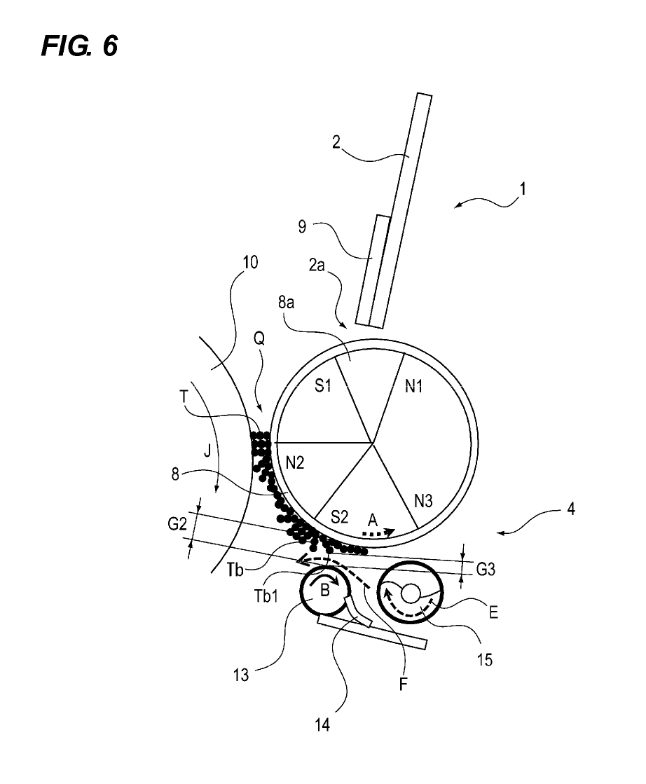

The toner scattering outside the developing container 2 from the gap G2 formed between the surface of the developing sleeve 8 and the surface of the collection roller 13 was observed using the present embodiment illustrated in FIG. 5 and Comparative Example 1 illustrated in FIG. 6. A sheet light source (which emits a laser beam as a sheet-like film of light) is used as a light source in order to specify only the toner scattering outside the developing container 2 from the gap G2 formed between the surface of the developing sleeve 8 illustrated in FIGS. 5 and 6 and the surface of the collection roller 13.

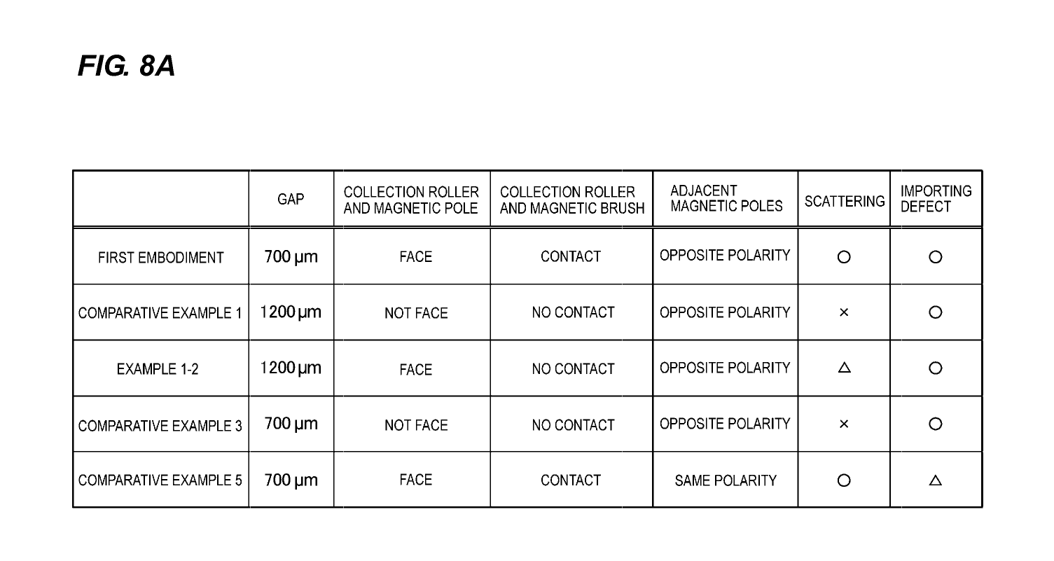

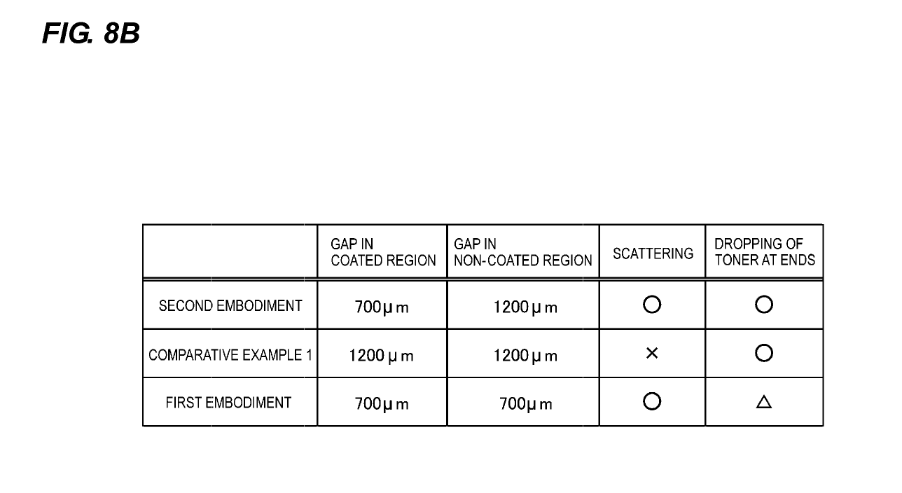

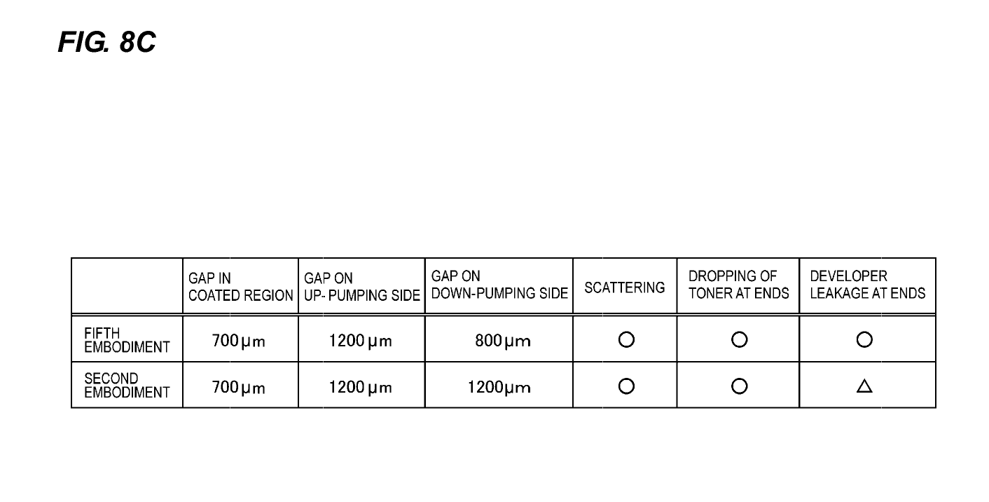

The toner was imaged by a high-speed camera (FASTCAM SA3 (model name) manufactured by Photron Inc.) from a cross-sectional direction of the developing device 1 (the developing container 2) illustrated in FIGS. 5 and 6. The toner scattering outside the developing container 2 from the gap G2 formed between the surface of the developing sleeve 8 and the surface of the collection roller 13 during operation of the developing device 1 was observed. The evaluation results are illustrated in FIG. 8A.

### Comparative Example 1

In Comparative Example 1 illustrated in FIG. 6, the importing magnetic pole S2 of the magnet roller 8a included in the developing sleeve 8 does not face the collection roller 13 but is disposed at a shifted position (non-facing position). Moreover, in Comparative Example 1 illustrated in FIG. 6, the gap G2 formed between the surface of the developing sleeve 8 and the surface of the collection roller 13 was set to 1200 μm. The importing magnetic pole S2 (S-polarity) disposed on the downstream side of the developing magnetic pole N2 has adjacent magnetic poles which include the developing magnetic pole N2 (N-polarity) and the magnetic pole N3 (N-polarity) which have the opposite polarity from the importing magnetic pole S2 similarly to the present embodiment illustrated in FIG. 5.

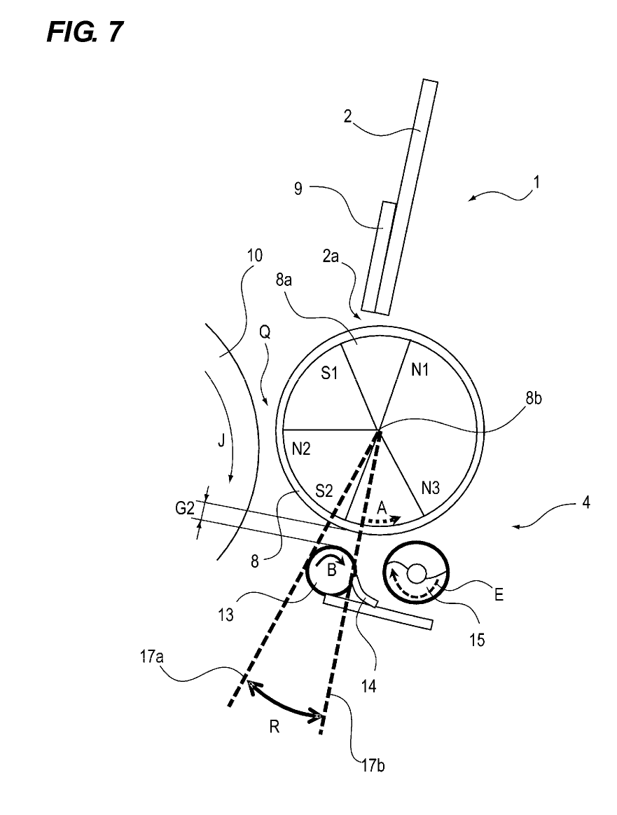

As a result, in Comparative Example 1 illustrated in FIG. 6, the magnetic brush Tb formed of the developer T born on the surface of the developing sleeve 8 slightly stands up near the importing magnetic pole S2. However, the importing magnetic pole S2 disposed closest to the collection roller 13 is disposed at a shifted position that does not face the collection roller 13. Here, the position (non-facing position) at which the pole position is shifted means that the magnetic pole position is shifted from a region R illustrated in FIG. 7, which will be described later. Further, the gap G2 is as large as 1200 μm. Thus, the distal end Tb1 of the magnetic brush Tb does not make contact with the surface of the collection roller 13.

In Comparative Example 1 illustrated in FIG. 6, the toner is stirred up by the conveying screw 15 that rotates in the direction indicated by arrow E in FIG. 6. The toner scatters outside the developing container 2 from the gap G2 formed between the surface of the developing sleeve 8 and the surface of the collection roller 13. It was observed that the scattering toner scattered outside the developing container 2 along arrow F in FIG. 6 in the rotation cycle of the conveying screw 15 (see “X” in FIG. 8A).

On the other hand, in the present embodiment illustrated in FIG. 5, the importing magnetic pole S2 of the magnet roller 8a included in the developing sleeve 8 faces the collection roller 13. Further, the gap G2 formed between the surface of the developing sleeve 8 and the surface of the collection roller 13 was set to 700 μm (<1200 μm).

As illustrated in FIG. 5, it was observed that the distal end Tb1 of the magnetic brush Tb formed of the developer T born on the surface of the developing sleeve 8 made contact with the surface of the collection roller 13. As a result, the toner is stirred up by the conveying screw 15 that rotates in the direction indicated by arrow E in FIG. 5. The toner is blocked by the magnetic brush Tb that forms a magnetic brush curtain in the gap G2 formed between the surface of the developing sleeve 8 and the surface of the collection roller 13 and does not scatter outside the developing container 2. Due to this, the toner scattering outside the developing container 2 from the gap G2 formed between the surface of the developing sleeve 8 and the surface of the collection roller 13 was rarely observed (see “◯” in FIG. 8A).

### Example 1-2

### Modified Embodiment

In this embodiment, the importing magnetic pole S2 which is one of the plurality of magnetic poles of the magnet roller 8a serving as a magnet member has the following configuration. As illustrated in FIG. 7, a peak position of the magnetic flux density of the importing magnetic pole S2 is disposed within the region R sandwiched between two tangent lines 17a and 17b that pass through a center of rotation 8b of the developing sleeve 8 and touch the surface of the collection roller 13.

In this embodiment, the gap G2 formed between the surface of the developing sleeve 8 and the surface of the collection roller 13 was set to 1200 μm similarly to Comparative Example 1 illustrated in FIG. 6. Further, the importing magnetic pole S2 (S-polarity) serving as the magnetic pole disposed at a position facing the collection roller 13 has adjacent magnetic poles which include the developing magnetic pole N2 (N-polarity) and the magnetic pole N3 (N-polarity) which have the opposite polarity from the importing magnetic pole S2 similarly to the first embodiment illustrated in FIG. 5.

In this embodiment (Example 1-2), the toner scattering outside the developing container 2 from the gap G2 formed between the surface of the developing sleeve 8 and the surface of the collection roller 13 during operation of the developing device 1 was observed. The evaluation results are illustrated in FIG. 8A.

In Example 1-2, similarly to the first embodiment illustrated in FIG. 5, the importing magnetic pole S2 of the magnet roller 8a included in the developing sleeve 8 faces the collection roller 13. Due to this, the magnetic brush Tb formed of the developer T born on the surface of the developing sleeve 8 in the gap G2 formed between the surface of the developing sleeve 8 and the surface of the collection roller 13 stands up in the radial direction of the developing sleeve 8 and the collection roller 13.

However, the gap G2 formed between the surface of the developing sleeve 8 and the surface of the collection roller 13 is set as wide as 1200 μm. Thus, the distal end Tb1 of the magnetic brush Tb formed of the developer T born on the surface of the developing sleeve 8 does not make contact with the surface of the collection roller 13. Thus, a magnetic brush curtain formed of the magnetic brush Tb is not completely formed in the gap G2.

Thus, in Example 1-2, the toner is stirred up by the conveying screw 15 that rotates in the direction indicated by arrow E in FIGS. 5 and 6. It was observed that the toner scattered outside the developing container 2 from the gap G2 formed between the surface of the developing sleeve 8 and the surface of the collection roller 13 (see “Δ” in FIG. 8A).

However, in Example 1-2, a magnetic pole is disposed in the facing portion between the developing sleeve 8 and the collection roller 13. Thus, as compared to a case (the configuration of Comparative Example 1 and the gap G2 of 1200 μm) in which the magnetic pole does not face the facing portion), it is possible to create a shape in which the magnetic brush Tb blocks the gap G2 between the developing sleeve 8 and the collection roller 13 and to obtain the effect of suppressing toner scattering. However, it is more preferable to allow the magnetic brush Tb to make contact with the developing sleeve 8 and the collection roller 13.

### Comparative Example 3

Next, in Comparative Example 3, the gap G2 formed between the surface of the developing sleeve 8 and the surface of the collection roller 13 was set as narrow as 700 μm similarly to the present embodiment illustrated in FIG. 5. Further, similarly to Comparative Example 1 illustrated in FIG. 6, the importing magnetic pole S2 of the magnet roller 8a included in the developing sleeve 8 does not face the collection roller 13 but is disposed at a shifted position (non-facing position). Further, the importing magnetic pole S2 (S-polarity) serving as the magnetic pole disposed closest to the collection roller 13 has adjacent magnetic poles which includes the developing magnetic pole N2 (N-polarity) and the magnetic pole N3 (N-polarity) which have the opposite polarity from the importing magnetic pole S2 similarly to the first embodiment illustrated in FIG. 5.

In Comparative Example 3, the toner scattering outside the developing container 2 from the gap G2 formed between the surface of the developing sleeve 8 and the surface of the collection roller 13 during operation of the developing device 1 was observed. The evaluation results are illustrated in FIG. 8A.

In Comparative Example 3, the importing magnetic pole S2 of the magnet roller 8a included in the developing sleeve 8 does not face the collection roller 13 similarly to Comparative Example 1 illustrated in FIG. 6. Thus, a magnetic brush curtain formed of the magnetic brush Tb is not formed in the gap G2 formed between the surface of the developing sleeve 8 and the surface of the collection roller 13.

Thus, the toner is stirred up by the conveying screw 15 that rotates in the direction indicated by arrow E in FIGS. 5 and 6. It was observed that the toner scattered outside the developing container 2 from the gap G2 formed between the surface of the developing sleeve 8 and the surface of the collection roller 13 (see “X” in FIG. 8A).

FIG. 8A illustrates the conditions of the configurations of the first embodiment illustrated in FIG. 5, Comparative Example 1 illustrated in FIG. 6, Example 1-2 as a modified embodiment of the first embodiment, and Comparative Example 3. The toner was stirred up by the conveying screw 15 that rotates in the direction indicated by arrow E in FIGS. 5 and 6. The observation results of the toner scattering outside the developing container 2 from the gap G2 formed between the surface of the developing sleeve 8 and the surface of the collection roller 13 are illustrated.

FIG. 8A illustrates the value of the gap G2 formed between the surface of the developing sleeve 8 and the surface of the collection roller 13. Further, the conditions whether the importing magnetic pole S2 of the magnet roller 8a included in the developing sleeve 8 faces the collection roller 13 or not are illustrated.

Further, the observation results whether the distal end Tb1 of the magnetic brush Tb formed of the developer T born on the surface of the developing sleeve 8 makes contact with the surface of the collection roller 13 are illustrated. The distal end makes contact with the surface when the magnetic brush curtain formed of the magnetic brush Tb is formed in the gap G2 formed between the surface of the developing sleeve 8 and the surface of the collection roller 13.

Further, whether a magnetic pole adjacent to the importing magnetic pole S2 of the magnet roller 8a included in the developing sleeve 8 has the opposite polarity from or the same polarity as the importing magnetic pole S2 is illustrated. Further, the toner is stirred up by the conveying screw 15 that rotates in the direction indicated by arrow E in FIGS. 5 and 6. The observation results whether the toner scatters outside the developing container 2 from the gap G2 formed between the surface of the developing sleeve 8 and the surface of the collection roller 13 are illustrated (“X” is assigned when toner scatters and “◯” is assigned when toner does not scatter).

Further, a surface layer of the developer T born on the surface of the developing sleeve 8 makes contact with the surface of the collection roller 13. Moreover, the observation results whether an importing defect in which toner is not imported into the developing container 2 but overflows outside the developing container 2 has occurred are illustrated (“◯” is assigned when an importing defect has not occurred and “Δ” is assigned when an importing defect has occurred). The importing defect did not occur in the first embodiment illustrated in FIG. 5, Comparative Example 1 illustrated in FIG. 6, Example 1-2 as a modified embodiment of the first embodiment, and Comparative Example 3 (see “◯” in FIG. 8A).

Similarly to the first embodiment illustrated in FIG. 5, the gap G2 formed between the surface of the developing sleeve 8 and the surface of the collection roller 13 is set to 700 μm. Further, the importing magnetic pole S2 of the magnet roller 8a included in the developing sleeve 8 faces the collection roller 13. Further, a magnetic pole adjacent to the importing magnetic pole S2 (S-polarity) disposed at a position facing the collection roller 13 includes the developing magnetic pole N2 (N-polarity) and the magnetic pole N3 (N-polarity) which have the opposite polarity from the importing magnetic pole S2.

In this way, the distal end Tb1 of the magnetic brush Tb formed of the developer T born on the surface of the developing sleeve 8 makes contact with the surface of the collection roller 13 to form a magnetic brush curtain in the gap G2 formed between the surface of the developing sleeve 8 and the surface of the collection roller 13.

In this way, the toner is stirred up by the conveying screw 15 that rotates in the direction indicated by arrow E in FIG. 5. The toner is blocked by the magnetic brush Tb that forms the magnetic brush curtain in the gap G2 formed between the surface of the developing sleeve 8 and the surface of the collection roller 13 and does not scatter outside the developing container 2.

The positional relation between the collection roller 13 and the importing magnetic pole S2 of the magnet roller 8a included in the developing sleeve 8 was examined. As a result, as illustrated in FIG. 7, the peak position of the magnetic flux density of the importing magnetic pole S2 may fall within the region R between the two tangent lines 17a and 17b drawn from the center of rotation 8b of the developing sleeve 8 illustrated in FIG. 7 toward the surface of the collection roller 13.

When the peak position of the magnetic flux density of the importing magnetic pole S2 falls within the region R illustrated in FIG. 7, it was observed that the distal end Tb1 of the magnetic brush Tb formed of the developer T born on the surface of the developing sleeve 8 makes contact with the surface of the collection roller 13 as illustrated in FIG. 5.

Here, whether the position of the importing magnetic pole S2 faces the collection roller 13 or not is defined as follows. That is, the case in which the importing magnetic pole S2 faces the collection roller 13 means that the peak position of the importing magnetic pole S2 is disposed in the region R of FIG. 7. Moreover, the case in which the importing magnetic pole S2 does not face the collection roller 13 means that the peak position of the importing magnetic pole S2 is not disposed in the region R of FIG. 7.

The half-width value of the peak value of the magnetic flux density of the importing magnetic pole S2 of the magnet roller 8a included in the developing sleeve 8 is increased. By doing so, it is possible to allow the distal end Tb1 of the magnetic brush Tb formed of the developer T born on the surface of the developing sleeve 8 to make contact with the surface of the collection roller 13.

In this case, the peak position of the magnetic flux density of the importing magnetic pole S2 may not necessarily fall within the region R between the two tangent lines 17a and 17b drawn from the center of rotation 8b of the developing sleeve 8 illustrated in FIG. 7 toward the surface of the collection roller 13.

Similarly to the present embodiment, the coating amount of the developer T born on the surface of the developing sleeve 8 is regulated to approximately 30 mg/cm² by the regulating blade 9. Moreover, the importing magnetic pole S2 of the magnet roller 8a included in the developing sleeve 8 faces the collection roller 13. The magnetic brush Tb formed of the developer T born on the surface of the developing sleeve 8 stands up in the gap G2 formed between the surface of the developing sleeve 8 and the surface of the collection roller 13. The length of the magnetic brush was approximately 900 μm at a farthest position between the surface of the developing sleeve 8 and the distal end Tb1 of the magnetic brush Tb.

When a gap G3 between the surface of the collection roller 13 and the distal end Tb1 of the magnetic brush Tb formed of the developer T born on the surface of the developing sleeve 8 illustrated in FIG. 6 is decreased as much as possible, a magnetic brush curtain effect is obtained to a certain extent.

However, if the gap G3 is too small, the coating amount of the developer T born on the surface of the developing sleeve 8 becomes large and the following problem occurs. An importing defect in which the surface layer of the developer T born on the surface of the developing sleeve 8 makes contact with the surface of the collection roller 13 and is not imported into the developing container 2 but overflows outside the developing container 2 may occur.

### Comparative Example 4

For example, in Comparative Example 4, the coating amount of the developer T born on the surface of the developing sleeve 8 of the developing device 1 illustrated in FIG. 5 is regulated to such a thickness as large as approximately 50 mg/cm² (>30 mg/cm²) by the regulating blade 9. Moreover, the gap G2 formed between the surface of the developing sleeve 8 and the surface of the collection roller 13 was set as narrow as 400 μm (<700 μm).

In the developing device 1 of Comparative Example 4, the coating amount of the developer T born on the surface of the developing sleeve 8 is as large as approximately 50 mg/cm² (>30 mg/cm²) and the gap G2 is as narrow as 400 μm (<700 μm). Thus, an importing defect in which the surface layer of the developer T born on the surface of the developing sleeve 8 makes contact with the surface of the collection roller 13 and is not imported into the developing container 2 but overflows outside the developing container 2 occurred. Thus, it is necessary to configure the developing device 1 within a range in which an importing defect as in Comparative Example 4 does not occur.

In the first embodiment illustrated in FIG. 5, the developing magnetic pole N2 (N-polarity) and the magnetic pole N3 (N-polarity) which convey the developer T and are adjacent to the importing magnetic pole S2 (S-polarity) of the magnet roller 8a included in the developing sleeve 8, facing the collection roller 13 have the opposite position from the importing magnetic pole S2.

A gap Gsd between the developing sleeve 8 and the photosensitive drum 10 is set to approximately 250 μm. Thus, the gap Gsd is smaller than the gaps G2 between the developing sleeve 8 and the collection roller 13 illustrated in FIGS. 8A to 8C. The force of causing the toner born on the surface of the developing sleeve 8 in the developing region Q to be adsorbed to the electrostatic latent image formed on the surface of the photosensitive drum 10 when a developing bias voltage is applied to the developing sleeve 8 is sufficiently large. Thus, the toner provided for developing in the developing region Q is not affected by the collection bias voltage applied to the collection roller 13 provided closer to the downstream side than the developing region Q.

### Comparative Example 5

For example, as illustrated by Comparative Example 5 in FIG. 8A, a case in which the importing magnetic pole S2 (S-polarity) that approaches closest to the collection roller 13 is formed as a repulsive pole will be considered. That is, a case in which a magnetic pole which conveys the developer T and is adjacent to the importing magnetic pole S2 on the downstream side has the same polarity (S-polarity) as the importing magnetic pole S2 will be considered. In this case, a repulsive magnetic field that generates a repulsive force is formed between the importing magnetic pole S2 (S-polarity) and the magnetic pole (S-polarity) for conveying the developer T. Thus, the repulsive magnetic field acts to displace the developer T from the surface of the developing sleeve 8.

Due to this, when the coating amount of the developer T born on the surface of the developing sleeve 8 is increased, the developer T is rarely imported into the developing container 2, and an importing defect is likely to occur (see “Δ” in FIG. 8A).

In Comparative Example 5 of FIG. 8A, the gap G2 formed between the surface of the developing sleeve 8 and the surface of the collection roller 13 is set to 700 μm. Further, the importing magnetic pole S2 of the magnet roller 8a included in the developing sleeve 8 faces the collection roller 13. In this way, the distal end Tb1 of the magnetic brush Tb formed of the developer T born on the surface of the developing sleeve 8 makes contact with the surface of the collection roller 13.

In this way, the toner is stirred up by the conveying screw 15 that rotates in the direction indicated by arrow E in FIG. 5. The toner is blocked by the magnetic brush Tb that forms a magnetic brush curtain in the gap G2 formed between the surface of the developing sleeve 8 and the surface of the collection roller 13 and does not scatter outside the developing container 2 (see “◯” in FIG. 8A).

For example, when the magnetic pole N3 (N-polarity) which is a magnetic pole for peeling the developer T, of the magnet roller 8a included in the developing sleeve 8 illustrated in FIG. 5 faces the collection roller 13, since the magnetic pole N3 repels the magnetic pole N1 (N-polarity), the developer T is likely to gather near the magnetic pole N3.

Thus, in the present embodiment, as illustrated in FIG. 5, the developing magnetic pole N2 (N-polarity) and the magnetic pole N3 (N-polarity) adjacent to the importing magnetic pole S2 (S-polarity) of the magnet roller 8a included in the developing sleeve 8, facing the collection roller 13 has the opposite polarity from the importing magnetic pole S2. However, as in Comparative Example 5, even when the importing magnetic pole S2 (S-polarity) is formed as a repulsive pole, the effect of suppressing toner scattering can be obtained.

According to the first embodiment illustrated in FIG. 5, the distal end Tb1 of the magnetic brush Tb formed of the developer T born on the surface of the developing sleeve 8 makes contact with the surface of the collection roller 13 in the gap G2 formed between the collection roller 13 and the developing sleeve 8. In this way, it is possible to form the magnetic brush curtain and to prevent the toner from scattering outside the developing container 2 from the gap G2.

### Second Embodiment

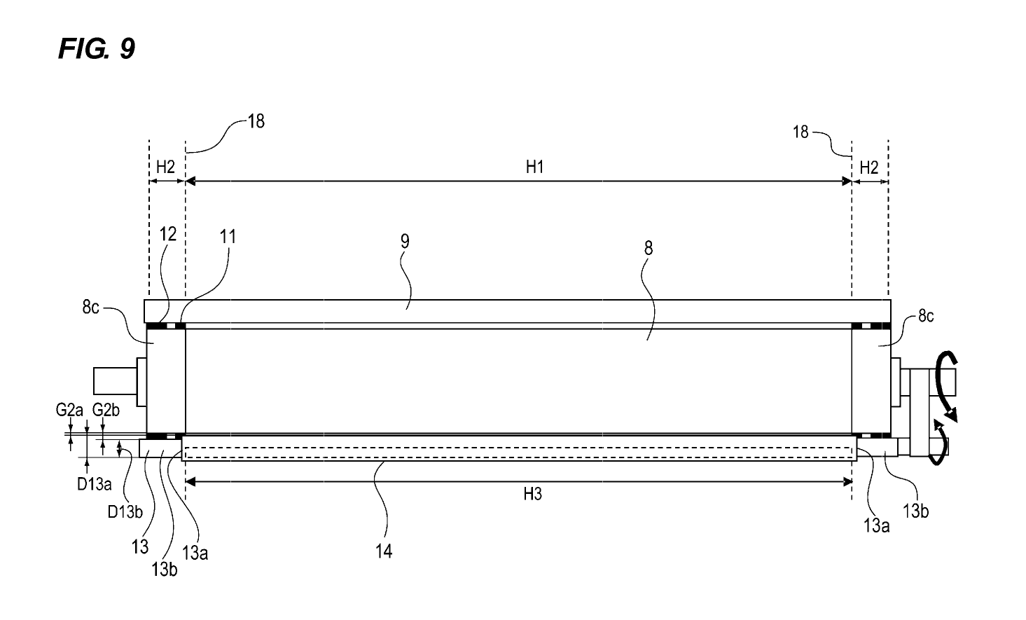

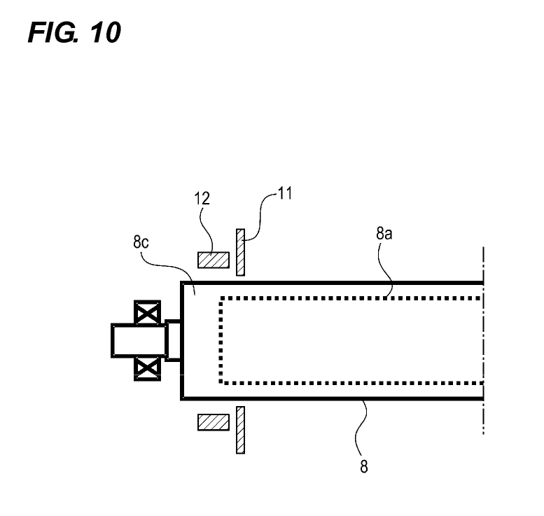

Next, a configuration of a second embodiment of the image forming apparatus having the developing device according to the present invention will be described with reference to FIGS. 9 and 10. The same constituent elements as those of the first embodiment will be denoted by the same reference numerals or the same element names, and the description thereof will not be provided.

In the first embodiment, the gap G2 between the surface of the developing sleeve 8 and the surface of the collection roller 13 and the positional relation between the collection roller 13 and the importing magnetic pole S2 of the magnet roller 8a included in the developing sleeve 8 are set appropriately. In this way, it is possible to allow the distal end Tb1 of the magnetic brush Tb formed of the developer T born on the surface of the developing sleeve 8 to make contact with the surface of the collection roller 13 to form a magnetic brush curtain to thereby prevent scattering toner.

A durability test was performed on 100,000 pages of the A4-size recording material 27 in a severe environment of a high temperature of 30° C. and high humidity of 80% using the image forming apparatus 16 having the developing device 1 of the first embodiment illustrated in FIG. 5. Dropping in which the toner separated from the magnetic carrier gathers in the non-coated regions H2 outside the coated region H1 at the ends 8c in the longitudinal direction (the left-right direction in FIG. 4) of the developing sleeve 8 illustrated in FIG. 4 and falls on the bottom surface of the developing container 2 illustrated in FIG. 2 occurred.

Thus, in the present embodiment, a configuration of suppressing dropping of the toner from the ends 8c in the longitudinal direction (the left-right direction in FIG. 4) of the developing sleeve 8 while preventing the toner from scattering outside the developing container 2 is employed.

In the present embodiment, as illustrated in FIG. 9, the collection roller 13 is configured as below. An outer diameter D13b of an end 13b in the longitudinal direction (the left-right direction in FIG. 9) of the collection roller 13 at a position facing the non-coated region H2 serving as a non-developer-bearing region in which the developer T is not born on the surface of the developing sleeve 8 is taken into consideration.

Further, an outer diameter D13a of a central portion in the longitudinal direction (the left-right direction in FIG. 9) of the collection roller 13 at a position facing the coated region H1 serving as a developer-bearing region in which the developer T is born on the surface of the developing sleeve 8 is taken into consideration.

Moreover, the outer diameter D13b is set to be smaller than the outer diameter D13a.

Due to this, as illustrated in FIG. 9, the gaps G2a and G2b formed between the collection roller 13 and the developing sleeve 8 are set such that the gap G2a in the coated region H1 of the developing sleeve 8 is larger than the gap G2b in the non-coated region H2.

In the present embodiment, as illustrated in FIG. 9, the portion of the collection roller 13 having the outer diameter D13a (D13a>D13b) extends toward the outer side than a boundary 18 of the coated region H1 of the developing sleeve 8.

Another boundary 13a of the outer diameters D13a and D13b of the collection roller 13 is set to a position separated by approximately 1 mm on the outer side of the boundary 18 between the coated region H1 and the non-coated region H2 of the developing sleeve 8. In this way, it is possible to prevent the formation of a large gap G2b in the coated region H1 of the developing sleeve 8 due to backlash or the like of the collection roller 13.

A durability test was performed on 100,000 pages of the A4-size recording material 27 in a severe environment of a high temperature of 30° C. and high humidity of 80% using the image forming apparatus 16 having the developing device 1 of the present embodiment illustrated in FIG. 9.

In the present embodiment, as illustrated in FIG. 8B, the gap G2a formed between the surface of the developing sleeve 8 and the surface of the collection roller 13 in the coated region H1 of the developing sleeve 8 was set to 700 μm.

Further, the gap G2b formed between the surface of the developing sleeve 8 and the surface of the collection roller 13 in the non-coated region H2 of the developing sleeve 8 was set to 1200 μm.

In the present embodiment, as illustrated in FIG. 8B, the amount of toner scattering outside the developing container 2 in the gap G2a formed in the coated region H1 of the developing sleeve 8 is small (see “◯” in FIG. 8B).

Further, dropping of toner from the end 8c in the longitudinal direction (the left-right direction in FIG. 9) of the developing sleeve 8 in the gap G2b formed in the non-coated region H2 of the developing sleeve 8 did not occur (see “◯” in FIG. 8B).

In the configuration of the developing device 1 of the present embodiment illustrated in FIG. 9, as illustrated in FIG. 8B, the amount of toner scattering outside the developing container 2 is small (see “◯” in FIG. 8B). Further, dropping of toner from the end 8c in the longitudinal direction (the left-right direction in FIG. 9) of the developing sleeve 8 did not occur (see “◯” in FIG. 8B). Thus, the developing device 1 provided satisfactory performance.

In contrast, in Comparative Example 1 illustrated in FIG. 6, the distal end Tb1 of the magnetic brush Tb formed of the developer T born on the surface of the developing sleeve 8 does not make contact with the surface of the collection roller 13.

Moreover, in Comparative Example 1 illustrated in FIG. 6, as illustrated in FIGS. 4 and 8B, the outer diameter D13 of the collection roller 13 was constant in the entire length in the longitudinal direction (the left-right direction in FIG. 4) of the coated region H1 and the non-coated region H2 of the developing sleeve 8. Further, the gap G2 formed between the surface of the developing sleeve 8 and the surface of the collection roller 13 was set to 1200 μm.

In Comparative Example 1 illustrated in FIG. 6, since the gap G2 is as large as 1200 μm, dropping of toner from the end 8c in the longitudinal direction of the developing sleeve 8 did not occur (see “◯” in FIG. 8B). However, since the distal end Tb1 of the magnetic brush Tb formed of the developer T born on the surface of the developing sleeve 8 was not in contact with the surface of the collection roller 13, toner scattered outside the developing container 2 (see “X” in FIG. 8B).

On the other hand, in the first embodiment illustrated in FIG. 5, as illustrated in FIGS. 4 and 8B, the outer diameter D13 of the collection roller 13 was constant in the entire length in the longitudinal direction (the left-right direction in FIG. 4) of the coated region H1 and the non-coated region H2 of the developing sleeve 8.

Further, the gap G2 formed between the surface of the developing sleeve 8 and the surface of the collection roller 13 was set as narrow as 700 μm. Moreover, as illustrated in FIG. 5, the distal end Tb1 of the magnetic brush Tb formed of the developer T born on the surface of the developing sleeve 8 makes contact with the surface of the collection roller 13 in the gap G2 formed between the collection roller 13 and the developing sleeve 8.

In the first embodiment illustrated in FIGS. 4 and 5, as illustrated in FIG. 8B, the level of toner scattering outside the developing container 2 was satisfactory (see “◯” in FIG. 8B). However, since the gap G2 was set as narrow as 700 μm, dropping of toner from the end 8c in the longitudinal direction of the developing sleeve 8 occurred (see “Δ” in FIG. 8B).

<Mechanism of Toner Leakage from Longitudinal End of Developing Sleeve>

Next, a mechanism in which toner leaks from the end 8c in the longitudinal direction (the left-right direction in FIG. 10) of the developing sleeve 8 will be described with reference to FIG. 10. FIG. 10 is an explanatory cross-sectional view illustrating a configuration around the end 8c in the longitudinal direction (the left-right direction in FIG. 10) of the developing sleeve 8. As illustrated in FIG. 10, a magnetic plate 11 serving as a magnetic sealing member is disposed in the end 8c in the longitudinal direction (the left-right direction in FIG. 10) of the developing sleeve 8 so as to surround the surface of the developing sleeve 8 in a non-contacting manner.

Due to this, the magnetic brush Tb formed of the developer T born on the surface of the developing sleeve 8 is formed between the magnet roller 8a in the developing sleeve 8 and the magnetic plate 11 which is a magnetic sealing member and the gap between the developing sleeve 8 and the developing container 2 is blocked. As a result, it is possible to suppress the toner from leaking from the gap between the developing sleeve 8 and the developing container 2 and suppress the toner from scattering outside the developing container 2.

When a weak magnetic-field region is present in a portion in the circumferential direction of the magnet roller 8a, the lines of magnetic force become sparse so that the magnetic brush Tb may be barely formed and a toner leakage may occur. When magnetic poles having the same polarity like the magnetic poles N1 and N3 (N-polarity) are present adjacent to each other in the magnet roller 8a illustrated in FIG. 5, the lines of magnetic force are not generated between the magnetic poles having the same polarity. Due to this, the lines of magnetic force become sparse in the region in which the magnetic poles having the same polarity are adjacent to each other, and a toner leakage may occur.

Thus, as illustrated in FIG. 10, a magnet sheet 12 is attached to an outer side of the magnetic plate 11 in the longitudinal direction (the left-right direction in FIG. 10) of the developing sleeve 8 to suppress a toner leakage. When the magnet sheet 12 is disposed, the lines of magnetic force are generated between the magnet sheet 12 and the magnetic plate 11 and the magnetic brush Tb is formed. Thus, the gap between the magnet sheet 12 and the magnetic plate 11 is blocked. Further, since the magnet sheet 12 captures the leaking toner, it is possible to suppress a toner leakage.

There is a limit in the amount of the developer that can be confined by the magnet sheet 12. Thus, it is not possible to completely prevent the occurrence of a toner leakage and scattering while maintaining long durability. Moreover, the sealing based on the magnetic brush Tb naturally does not create perfect hermetical sealing. Thus, when the magnet sheet 12 is pressed by force equal to or greater than magnetic attraction during a long period of use, the developer T that forms the magnetic brush Tb will be removed from the magnet sheet 12 and may cause a toner leakage.

Moreover, when the magnetic brush Tb held on the magnet sheet 12 makes contact with the non-coated region H2 of the developing sleeve 8 and a rubbing state continues, the toner in the developer T held on the magnet sheet 12 will be separated and may cause dropping of the toner from the end 8c in the longitudinal direction of the developing sleeve 8.

In particular, similarly to the first embodiment illustrated in FIG. 8B, the gap G2 formed between the surface of the developing sleeve 8 and the surface of the collection roller 13 in the entire longitudinal direction of the developing sleeve 8 was set as narrow as 700 μm.

In this case, the distal end Tb1 of the magnetic brush Tb formed of the developer T born on the surface of the developing sleeve 8 makes contact with the surface of the collection roller 13 in the coated region H1 of the developing sleeve 8 to form a magnetic brush curtain.

Thus, air in the developing container 2 cannot leak from the gap G2 formed between the surface of the developing sleeve 8 and the surface of the collection roller 13.

In Comparative Example 1 illustrated in FIG. 6, the air in the developing container 2 leaked from the gap G2 formed between the surface of the developing sleeve 8 and the surface of the collection roller 13. Similarly to the first embodiment illustrated in FIG. 5, the distal end Tb1 of the magnetic brush Tb formed of the developer T born on the surface of the developing sleeve 8 makes contact with the surface of the collection roller 13 to form a magnetic brush curtain.

By doing so, the air in the developing container 2 cannot escape the developing container 2. Thus, the internal pressure of the developing container 2 increases, and the air in the developing container 2 escapes toward the end 8c in the longitudinal direction (the left-right direction in FIG. 10) of the developing sleeve 8. Thus, the toner is pushed by the air and leaks from the end 8c in the longitudinal direction of the developing sleeve 8.

Therefore, as compared to Comparative Example 1 illustrated in FIG. 6, in the first embodiment illustrated in FIG. 5, force is applied in the direction toward the magnet sheet 12 illustrated in FIG. 10 to cause a toner leakage or accelerate the dropping of the toner from the end 8c in the longitudinal direction of the developing sleeve 8.

In the configuration of the developing device 1 of the present embodiment illustrated in FIG. 9, the gap G2b formed between the surface of the developing sleeve 8 and the surface of the collection roller 13 in the non-coated region H2 of the end 8c in the longitudinal direction (the left-right direction in FIG. 9) of the developing sleeve 8 is taken into consideration.

Further, the gap G2a formed between the surface of the developing sleeve 8 and the surface of the collection roller 13 in the coated region H1 at the center of the developing sleeve 8 is taken into consideration. Moreover, the gap G2b is set to be larger than the gap G2a.

Due to this, the air which were unable to leak in the coated region H1 of the developing sleeve 8 can leak from the large gap G2b in the non-coated region H2. Thus, it is possible to decrease the pressure applied in the direction toward the magnet sheet 12 illustrated in FIG. 10.

As a result, it is possible to prevent scattering of toner in the coated region H1 of the developing sleeve 8 (see “◯” in FIG. 8B) and to suppress the dropping of toner from the end 8c in the longitudinal direction of the developing sleeve 8 in the non-coated region H2 (see “◯” in FIG. 8B).

A scraper region H3 illustrated in FIG. 9 is a region in which the developer T collected to the surface of the collection roller 13 is scraped by the scraper 14. The other configuration is the same as that of the first embodiment, and the same effect can be obtained.

### Third Embodiment

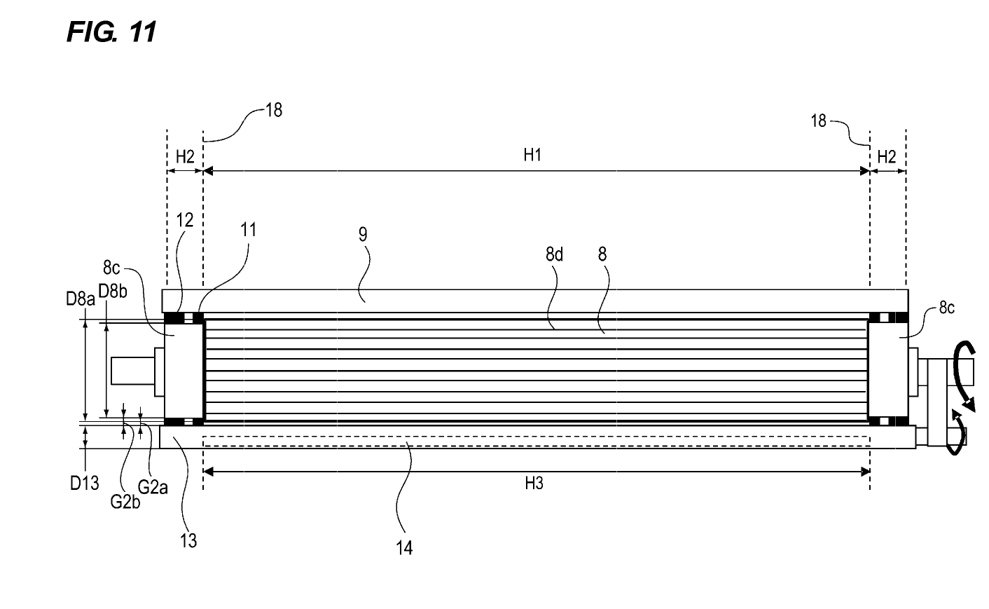

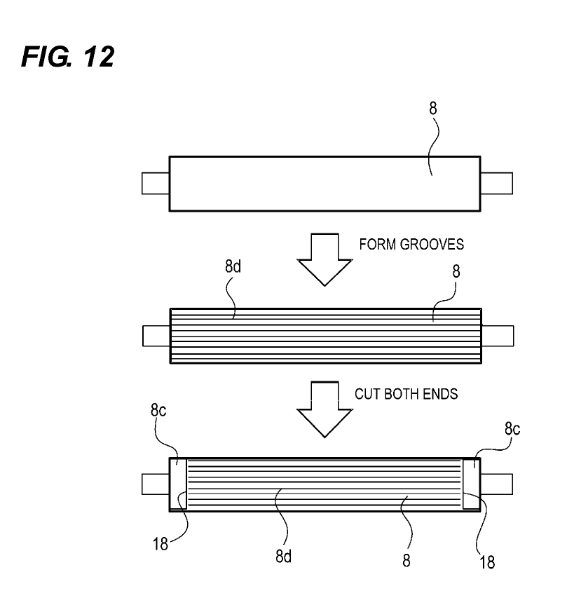

Next, a configuration of a third embodiment of the image forming apparatus having the developing device according to the present invention will be described with reference to FIGS. 11 and 12. The same constituent elements as those of the above-described embodiments will be denoted by the same reference numerals or the same element names, and the description thereof will not be provided.

In the second embodiment, as illustrated in FIG. 9, the outer diameters D13a and D13b of the collection roller 13 in the coated region H1 and the non-coated region H2 of the developing sleeve 8 was set to be different (D13a>D13b).

Thus, the gap G2b formed between the surface of the developing sleeve 8 and the surface of the collection roller 13 in the non-coated region H2 of the developing sleeve 8 was taken into consideration.

Further, the gap G2a formed between the surface of the developing sleeve 8 and the surface of the collection roller 13 in the coated region H1 of the developing sleeve 8 was taken into consideration.

Moreover, the gap G2b was set to be larger than the gap G2a. In this way, it was possible to suppress scattering of toner and the dropping of toner from the end in the longitudinal direction of the developing sleeve 8.

In the present embodiment, in the developing sleeve 8 illustrated in FIG. 11, the outer diameter D8b in the non-coated region H2 of the end 8c in the longitudinal direction (the left-right direction in FIG. 11) of the developing sleeve 8 is taken into consideration.

Further, the outer diameter D8a in the coated region H1 in the central portion in the longitudinal direction (the left-right direction in FIG. 11) of the developing sleeve 8 is taken into consideration. Moreover, the outer diameter D8b is set to be smaller than the outer diameter D8a.

In this way, as illustrated in FIG. 11, the gap G2a formed between the surface of the developing sleeve 8 and the surface of the collection roller 13 in the coated region H1 in the central portion in the longitudinal direction (the left-right direction in FIG. 11) of the developing sleeve 8 is taken into consideration.

Further, the gap G2b formed between the surface of the developing sleeve 8 and the surface of the collection roller 13 in the non-coated region H2 of the end 8c of the developing sleeve 8 is taken into consideration. Moreover, the gap G2a can be set to be larger than the gap G2b.

In the present embodiment, as illustrated in FIG. 11, the portion of the collection roller 13 having the outer diameter D13 extends at least toward the outer side than the boundary 18 of the coated region H1 of the developing sleeve 8.

For example, as illustrated in FIG. 12, the developing sleeve 8 in which a plurality of grooves 8d is formed on the surface of the developing sleeve 8 along the longitudinal direction (the left-right direction in FIG. 12) of the developing sleeve 8 so as to be arranged regularly in the circumferential direction of the developing sleeve 8 may be employed.

As a method of manufacturing the developing sleeve 8 illustrated in FIG. 12, first, the plurality of grooves 8d is formed on the surface of the developing sleeve 8 so as to extend in an entire area in the longitudinal direction (the left-right direction in FIG. 12) of the developing sleeve 8 and the entire circumference in the circumferential direction of the developing sleeve 8 by extraction or extrusion molding. After that, the surface of the end 8c in the longitudinal direction (the left-right direction in FIG. 12) of the developing sleeve 8 is cut at least to the depth or more of the groove 8d. In this way, a non-groove portion is formed in the end 8c in the longitudinal direction (the left-right direction in FIG. 12) of the developing sleeve 8.

In this way, as illustrated in FIG. 11, the coated region H1 is formed in the central portion in the longitudinal direction (the left-right direction in FIG. 11) of the developing sleeve 8. Further, the non-coated region H2 is formed in the end 8c in the longitudinal direction (the left-right direction in FIG. 11) of the developing sleeve 8 so as to be adjacent to the coated region H1 with the boundary 18 interposed.

Since the groove 8d is cut in the non-coated region H2 in the end 8c of the developing sleeve 8, the outer diameter D8b of the end 8c is smaller than the outer diameter D8a of the developing sleeve 8 in the coated region H1 in the central portion in the longitudinal direction (the left-right direction in FIG. 11) of the developing sleeve 8.

In the present embodiment, the depth of the groove 8d formed on the surface of the developing sleeve 8 is 80 μm. In order to form the non-groove portion in the end 8c of the developing sleeve 8, the end 8c is cut 100 μm from the outer diameter D8a of the developing sleeve 8. In this way, the outer diameter D8b in the end 8c of the developing sleeve 8 was set (D8b=D8a −100 μm).

In the present embodiment, 80 grooves 8d were formed on the surface of the developing sleeve 8 in the entire circumference of the developing sleeve 8 at an equal interval in the circumferential direction and in parallel in the longitudinal direction (the left-right direction in FIG. 11) of the developing sleeve 8. The other configuration is the same as that of the above-described embodiment, and the same effect can be obtained.

### Fourth Embodiment

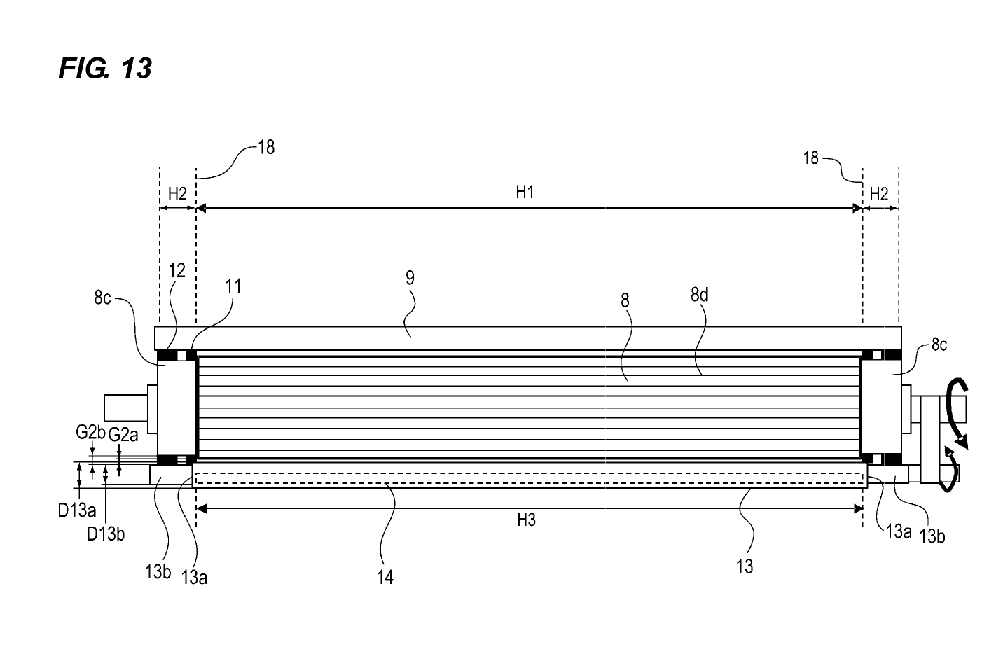

Next, a configuration of a fourth embodiment of the image forming apparatus having the developing device according to the present invention will be described with reference to FIG. 13. The same constituent elements as those of the above-described embodiments will be denoted by the same reference numerals or the same element names, and the description thereof will not be provided.

The present embodiment illustrated in FIG. 13 combines the second embodiment illustrated in FIG. 9 and the third embodiment illustrated in FIG. 11.

In the present embodiment, as illustrated in FIG. 13, the gap G2a formed between the surface of the developing sleeve 8 and the surface of the collection roller 13 in the coated region H1 of the developing sleeve 8 is further taken into consideration than the second and third embodiments.

Further, the gap G2b formed between the surface of the developing sleeve 8 and the surface of the collection roller 13 in the non-coated region H2 in the end 8c of the developing sleeve 8 is taken into consideration. Moreover, the gap G2a can be set to be larger than the gap G2b.

In the present embodiment, as illustrated in FIG. 13, the portion of the collection roller 13 having the outer diameter D13a extends at least toward the outer side than the boundary 18 of the coated region H1 of the developing sleeve 8.

In the present embodiment, the end 13b of the collection roller 13 was cut 100 μm from the outer diameter D13a so that the outer diameter D13b in the end 13b of the collection roller 13 was set (D13b=D13a−100 μm). In this way, the gap G2b formed between the surface of the developing sleeve 8 and the surface of the collection roller 13 in the non-coated region H2 in the end 8c of the developing sleeve 8 was set to 200 μm. The other configuration is the same as that of the above-described embodiments, and the same effect can be obtained.

### Fifth Embodiment

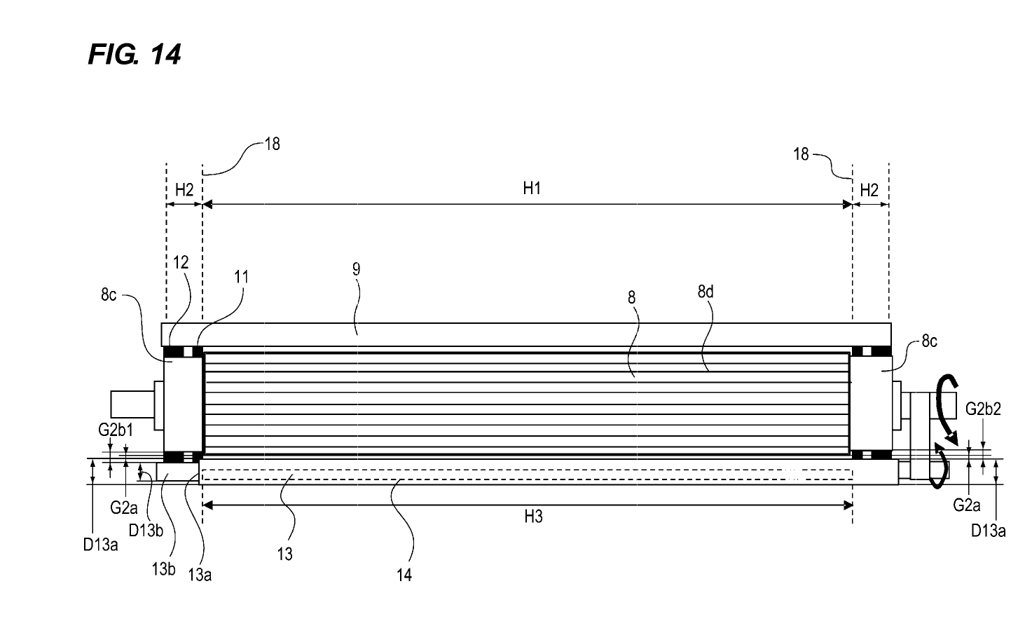

Next, a configuration of a fifth embodiment of the image forming apparatus having the developing device according to the present invention will be described with reference to FIG. 14. The same constituent elements as those of the above-described embodiments will be denoted by the same reference numerals or the same element names, and the description thereof will not be provided.

In the second to fourth embodiments, the gap G2b formed between the surface of the developing sleeve 8 and the surface of the collection roller 13 in the non-coated region H2 of the developing sleeve 8 was increased. In this way, it was possible to suppress scattering of toner and the dropping of toner from the end in the longitudinal direction of the developing sleeve 8.

In the present embodiment, as illustrated in FIG. 14, gaps G2b1 and G2b2 formed between the surface of the developing sleeve 8 and the surface of the collection roller 13 in the non-coated regions H2 of the developing sleeve 8 are set to be different on the left and right sides of FIG. 14.

As illustrated in FIG. 14, the gaps G2a, G2b1, and G2b2 formed between the surface of the developing sleeve 8 and the surface of the collection roller 13 are set as below. The gap G2b1 in one end (the left end in FIG. 14) in the longitudinal direction (the left-right direction in FIG. 14) in the non-coated region H2 of the developing sleeve 8 is defined as “Ge1”. Further, the gap G2b2 in the other end (the right end in FIG. 14) in the longitudinal direction (the left-right direction in FIG. 14) in the non-coated region H2 of the developing sleeve 8 is defined as “Ge2”.

Further, the gap G2a in the central portion in the longitudinal direction (the left-right direction in FIG. 14) in the coated region H1 of the developing sleeve 8 is defined as “Gc”. In this case, the gaps are set by the relation of Mathematical Expression 1 below.

Ge1>Ge2>Gc [Math. 1]

In the present embodiment, the gaps G2b1 and G2b2 formed between the surface of the developing sleeve 8 and the surface of the collection roller 13 in the non-coated region H2 in the ends 8c in the longitudinal direction (the left-right direction in FIG. 14) of the developing sleeve 8 are set as below.

The gaps G2b1 and G2b2 are set to be larger than the gap G2a formed between the surface of the developing sleeve 8 and the surface of the collection roller 13 in the coated region H1 in the central portion in the longitudinal direction (the left-right direction in FIG. 14) of the developing sleeve 8.

Further, the gap G2b1 formed between the surface of the developing sleeve 8 and the surface of the collection roller 13 in the non-coated region H2 in the end 8c in the longitudinal direction (the left-right direction in FIG. 14) of the developing sleeve 8 on the left side (the up-pumping side) of FIG. 14 is set as below.

The gap G2b1 is set to be larger than the gap G2b2 formed between the surface of the developing sleeve 8 and the surface of the collection roller 13 in the non-coated region H2 in the end 8c in the longitudinal direction (the left-right direction in FIG. 14) of the developing sleeve 8 on the right side (down-pumping side) of FIG. 14.

In the present embodiment, as illustrated in FIG. 14, the portion of the collection roller 13 having the outer diameter D13a extends at least toward the outer side than the boundary 18 of the coated region H1 of the developing sleeve 8.

As described above with reference to FIGS. 2 and 3, in the developing device 1 in which the developing chamber 3 and the agitation chamber 4 are disposed vertically, the developer level on the up-pumping side illustrated on the left side of FIG. 3 increases. Thus, the conveying screw 15 illustrated in FIG. 2 conveys the developer T in the agitation chamber 4 from the up-pumping side illustrated on the left side of FIG. 3 toward the down-pumping side illustrated on the right side of FIG. 3. The conveying screw 15 illustrated in FIG. 2 conveys the developer T in the agitation chamber 4 in the opposite direction from the conveying screw 6. In this way, the developer level in the agitation chamber 4 can be equalized to some extent.

Thus, as illustrated in FIG. 2, the developer T is conveyed to the downstream side (the right side in FIGS. 3 and 14) in the developer conveying direction of the conveying screw 15 disposed near the collection roller 13. Moreover, the developer T may leak from the gap G2b2 in the right end of FIG. 14 in the longitudinal direction of the developing sleeve 8 illustrated in FIG. 14.

In the present embodiment, on the up-pumping side illustrated on the left side of FIG. 14, the gap G2b1 formed between the surface of the developing sleeve 8 and the surface of the collection roller 13 in the non-coated region H2 was set as wide as 1200 μm as illustrated in FIG. 8C.

Further, on the down-pumping side illustrated on the right side of FIG. 14, the gap G2b2 was set as narrow as 800 μm as illustrated in FIG. 8C to such an extent that the developer T does not leak.

In the present embodiment, as illustrated in FIG. 8C, the gap G2a formed between the surface of the developing sleeve 8 and the surface of the collection roller 13 in the coated region H1 in the central portion in the longitudinal direction (the left-right direction in FIG. 14) of the developing sleeve 8 was set to 700 μm.

Further, the gap G2b1 on the up-pumping side illustrated on the left side of FIG. 14 was set to 1200 μm. Further, the gap G2b2 was set to 800 μm.

In the present embodiment, scattering of toner, the dropping of toner from the end in the longitudinal direction of the developing sleeve 8, and the leakage of the developer T did not occur (see “◯” in FIG. 8C).

On the other hand, in the second embodiment illustrated in FIG. 9, as illustrated in FIG. 8C, the gap G2a formed between the surface of the developing sleeve 8 and the surface of the collection roller 13 in the coated region H1 in the central portion in the longitudinal direction (the left-right direction in FIG. 9) of the developing sleeve 8 was set to 700 μm.

Further, the gap G2b on the up-pumping side illustrated on the left side of FIG. 9 was set to 1200 μm the same as that on the down-pumping side illustrated in the right side of FIG. 9.

In the second embodiment illustrated in FIG. 9, scattering of toner, the dropping of toner from the end in the longitudinal direction of the developing sleeve 8 did not occur (see “◯” in FIG. 8C). However, the gap G2b on the down-pumping side illustrated on the right side of FIG. 9 was set as wide as 1200 μm.

Thus, the developer T did not leak from the gap G2b (see “Δ” in FIG. 8C). The other configuration is the same as that of the first embodiment, and the same effect can be obtained.

According to the configuration, it is possible to suppress toner from scattering from the gap formed between the surface of the developer bearing member and the surface of the collection rotating member even when the processing speed increases.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-195947, filed Sep. 26, 2014, which is hereby incorporated by reference herein in its entirety.

1. A developing device comprising:
a developing container which stores developer;
a developer bearing member which develops an electrostatic latent image, the developer bearing member being provided in an opening formed in the developing container so as to be rotatable in relation to the developing container in a state in which a surface thereof is partially exposed;
a magnet member which is disposed in the developer bearing member and has a plurality of magnetic poles in a circumferential direction of the developer bearing member in order to allow developer to be born on a surface of the developer bearing member;
a collection rotating member disposed in the opening of the developing container closer to an opening end formed on a downstream side in a rotation direction of the developer bearing member so as to face the developer bearing member at an interval from the developer bearing member and collect toner by rotating so that surfaces of the developer bearing member and the collection rotating member move in the same direction at proximal positions thereof; and
a bias application device which applies a bias to the collection rotating member so that an electric field is formed so that force directed from the collection rotating member toward the developer bearing member acts on normally charged toner, wherein
a distal end of a magnetic brush formed of the developer born on the surface of the developer bearing member by the magnet member is set so as to make contact with the surface of the collection rotating member,
the developer bearing member has a developer-bearing region formed so that the developer is born on a surface thereof, and a non-developer-bearing region formed so that the developer is not born, and
a first gap is set between the collection rotating member and the developer-bearing region and a second gap larger than the first gap is set between the collection rotating member and the non-developer-bearing region.

2. A developing device comprising:
a developing container which stores developer;
a developer bearing member which develops an electrostatic latent image, the developer bearing member being provided in an opening formed in the developing container so as to be rotatable in relation to the developing container in a state in which a surface thereof is partially exposed;
a magnet member which is disposed in the developer bearing member and has a plurality of magnetic poles in a circumferential direction of the developer bearing member in order to allow developer to be born on a surface of the developer bearing member;
a collection rotating member disposed in the opening of the developing container closer to an opening end formed on a downstream side in a rotation direction of the developer bearing member so as to face the developer bearing member at an interval from the developer bearing member and collect toner by rotating so that surfaces of the developer bearing member and the collection rotating member move in the same direction at proximal positions thereof; and
a bias application device which applies a bias to the collection rotating member so that an electric field is formed so that force directed from the collection rotating member toward the developer bearing member acts on normally charged toner, wherein
in one of the plurality of magnetic poles, a peak position of the magnetic flux density is disposed within a region sandwiched between two tangent lines that pass through a center of the developer bearing member and touch the collection rotating member,
the developer bearing member has a developer-bearing region formed so that the developer is born on a surface thereof, and a non-developer-bearing region formed so that the developer is not born, and
a first gap is set between the collection rotating member and the developer-bearing region and a second gap larger than the first gap is set between the collection rotating member and the non-developer-bearing region.

3. The developing device according to claim 1 or 2, wherein
a magnetic pole disposed at a position closest to the collection rotating member has adjacent magnetic poles which have an opposite polarity from the magnetic pole.

4. The developing device according to claim 1 or 2, further comprising:
a first conveying screw provided in a developing chamber;
a second conveying screw provided in an agitation chamber; and
a third conveying screw provided in the agitation chamber at a position closer to an upstream side than the second conveying screw in a rotation direction of the developer bearing member so as to convey the developer in the opposite direction from a developer conveying direction of the second conveying screw, wherein
the gap formed between the collection rotating member and the developer bearing member is set so as to satisfy a relation of Ge1>Ge2>Gc in which Ge1 is a gap on an upstream side in a developer conveying direction of the third conveying screw, formed at one end in a longitudinal direction in the non-developer-bearing region of the developer bearing member, Ge2 is a gap on a downstream side in the developer conveying direction of the third conveying screw, formed at the other end, and Gc is a gap in a central portion in the longitudinal direction in the developer-bearing region of the developer bearing member.

5. The developing device according to claim 1, wherein
the collection rotating member is set so that an outer diameter at a position of the developer facing the non-developer-bearing region of the developer bearing member is smaller than an outer diameter at a position facing the developer-bearing region of the developer bearing member.

6. The developing device according to claim 1, wherein
the developer bearing member is set so that an outer diameter in the non-developer-bearing region is smaller than an outer diameter in the developer-bearing region.

7. The developing device according to claim 1, wherein
a collection bias voltage having a DC component at which the normally charged toner rarely adheres to the collection rotating member as compared to a DC component of a developing bias voltage applied to the developer bearing member is applied to the collection rotating member.

8. An image forming apparatus which forms an image on a recording material, comprising:
the developing device according to claim 1; and
an image bearing member which rotates in a predetermined direction while bearing an electrostatic latent image thereon.

9. The developing device according to claim 2, wherein
a magnetic pole disposed at a position closest to the collection rotating member has adjacent magnetic poles which have an opposite polarity from the magnetic pole.

10. The developing device according to claim 2, further comprising:
a first conveying screw provided in a developing chamber;
a second conveying screw provided in an agitation chamber; and
a third conveying screw provided in the agitation chamber at a position closer to an upstream side than the second conveying screw in a rotation direction of the developer bearing member so as to convey the developer in the opposite direction from a developer conveying direction of the second conveying screw, wherein
the gap formed between the collection rotating member and the developer bearing member is set so as to satisfy a relation of Ge1>Ge2>Gc in which Ge1 is a gap on an upstream side in a developer conveying direction of the third conveying screw, formed at one end in a longitudinal direction in the non-developer-bearing region of the developer bearing member, Ge2 is a gap on a downstream side in the developer conveying direction of the third conveying screw, formed at the other end, and Gc is a gap in a central portion in the longitudinal direction in the developer-bearing region of the developer bearing member.

11. The developing device according to claim 2, wherein
the collection rotating member is set so that an outer diameter at a position of the developer facing the non-developer-bearing region of the developer bearing member is smaller than an outer diameter at a position facing the developer-bearing region of the developer bearing member.

12. The developing device according to claim 2, wherein
the developer bearing member is set so that an outer diameter in the non-developer-bearing region is smaller than an outer diameter in the developer-bearing region.

13. The developing device according to claim 2, wherein
a collection bias voltage having a DC component at which the normally charged toner rarely adheres to the collection rotating member as compared to a DC component of a developing bias voltage applied to the developer bearing member is applied to the collection rotating member.

14. An image forming apparatus which forms an image on a recording material, comprising:
the developing device according to claim 2; and
an image bearing member which rotates in a predetermined direction while bearing an electrostatic latent image thereon.
